(19) United States
(12) Patent Application Publication
(10) Pub. No.: US 2007/0053246 A1
(43) Pub. Date: Mar. 8, 2007

(54) Recording/reproducing apparatus, and associated content display control method

(75) Inventors: Tadayuki Sano, Kanagawa (JP); Tomomi Tsuchiya, Tokyo (JP); Hiroshi Ito, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-ku (JP)

(21) Appl. No.: 11/448,850

(22) Filed: Jun. 8, 2006

(30) Foreign Application Priority Data
Sep. 7, 2005 (JP) 2005-259765

(51) Int. Cl. G11B 21/08

(52) U.S. Cl. 369/30.04

(57) ABSTRACT

The invention provides a recording/reproducing, including a display control performed such that when a reproduction mode is a shuffle reproduction mode, a predetermined number of pieces of selection candidate information of a plurality of pieces of selection candidate information are displayed on a display portion so as to be sequentially replaced with one another over a predetermined period of time. In the shuffle reproduction mode, the pieces of selection candidate information are displayed on the display portion so as to be sequentially replaced with one another, a user can readily and reliably recognize that the current reproduction mode by such sequential display. In addition, it is possible to make such direction as to perform random selection. Also, such sequential display is performed during the shuffle reproduction mode, whereby it is possible to further enhance the amusementability of the shuffle reproduction.

### BACKGROUND OF THE INVENTION

The present invention relates to a recording/reproducing apparatus and a display control method thereof.

The “background” description provided herein is for the purpose of generally describing the context of the invention. Work of the presently named inventors described in this description, as well as aspects of the description which may not otherwise qualify as prior art at the time of filing, are neither expressly or impliedly admitted as prior art against the present invention.

Heretofore, a very compact portable type recording/reproducing apparatus having a small recording medium built therein such as a semiconductor memory has come into wide use.

Such a portable type recording/reproducing apparatus can make data communication with an information processor such as a personal computer, and can download musical data stored in the information processor to accumulate therein the musical data thus downloaded.

At this time, the musical data on the information processor side is managed by dedicated application software. That is to say, such dedicated application software is installed in the information processor side, whereby fetching of the musical piece data from a Compact Disc (CD) or the like and editing of the musical piece data (e.g., classification of the musical piece data in albums, production of a playlist, etc.) can be readily performed. Some applications each include a function of downloading the musical piece data stored in the information processor into the recording/reproducing apparatus side. Thus, a user can simply download the musical piece data from the information processor into the recording/reproducing apparatus by performing an operation in accordance with guidance displayed on a screen by the application.

Now, in such a portable type recording/reproducing apparatus, the large capacity promotion has progressed in terms of a storage capacity as well for the musical piece data along with the recent large capacity promotion for the recording medium. For example, even in the portable type recording/reproducing apparatus including a semiconductor memory as a recording medium, a storage capacity of about several hundred megabytes (MB) to about several gigabytes (GB) can be secured. Along with this, the musical piece data of about several hundred files of music to about one thousand files of music can be accumulated in some cases. In a case where a large quantity of musical piece data is stored in such a manner, when all the musical piece data is made objects of reproduction and thus the musical piece data is usually reproduced in the same order of music, there is the possibility that it takes time for the user to retrieve his/her favorite music or he/she grows tired of the reproduction in the same order.

### SUMMARY OF THE INVENTION

The present invention provides a recording/reproducing apparatus including a reproducing section configured to reproduce data from a recording medium in which at least content data and its additive data are recorded. A control section is configured to display a plurality of pieces of selection candidate object information in correspondence to content data, sequentially for a predetermined time on a display portion when a shuffle reproduction mode is selected.

In a further aspect of the invention, a display control method for a recording/reproducing apparatus is provided. A shuffle reproduction mode is selected. A plurality of selection candidate object information is sequentially displayed in correspondence to content data recorded in the reproducing apparatus for a predetermined period of time.

It is to be understood that both the foregoing general description of the invention and the following detailed description are exemplary, but are not restrictive, of the invention.

### BRIEF DESCRIPTION OF THE SEVERAL VIEWS OF THE DRAWINGS

A more complete appreciation of the invention and many of the attendant advantages thereof will be readily obtained as the same becomes better understood by reference to the following detailed description when considered in connection with the accompanying drawings wherein:

FIG. 1 is a high level block diagram of a recording/reproducing system according to an exemplary embodiment of the present invention;

FIG. 2 is a block diagram showing an internal configuration of an information processor according to the exemplary embodiment of the present invention;

FIG. 3 is a block diagram of a contents management application of the information processor according to the exemplary embodiment of the present invention;

FIG. 4 is a data structure diagram of a structure of the contents management application of FIG. 3;

FIG. 5 is a diagram of an order list for reproduction times;

FIG. 6 is a diagram of an artist link list;

FIG. 7 is a diagram of a released year list;

FIG. 8 is a block diagram of an internal structure of a recording/reproducing apparatus according to the exemplary embodiment of the present invention;

FIGS. 9A and 9B are respectively external views of the recording/reproducing apparatus according to the exemplary embodiment of the present invention;

FIG. 10 is a diagram of reproducing (receiving) functions of the recording/reproducing apparatus according to the exemplary embodiment of the present invention;

FIG. 11 is a diagram of an operation procedure of functions of the recording/reproducing apparatus are selected from a function selection screen;

FIGS. 12A to 12D are diagrams of an artist reproducing function;

FIGS. 13A to 13C are diagrams of an album reproducing function of the exemplary embodiment of the invention;

FIGS. 14A to 14F are diagrams of image changes of My Favorite Shuffle reproduction;

FIGS. 15A to 15G are diagrams of image changes during Artist Link Shuffle reproduction of the exemplary embodiment of the invention;

FIGS. 16A to 16F are diagrams of Time Machine Shuffle reproduction of the exemplary embodiment of the invention;

FIGS. 17A to 17E are diagrams of Sports Shuffle reproduction of the exemplary embodiment of the invention;

FIG. 18 is a flow chart of a processing operation of the My Favorite Shuffle reproduction phase according to an exemplary embodiment of the invention;

FIG. 19 is a flow chart of an Artist Link Shuffle reproduction phase according to the exemplary embodiment of the invention;

FIG. 20 is a flow chart of a processing operation to the Time Machine Shuffle reproduction phase according to the exemplary embodiment of the invention;

FIG. 21 is a diagram of a sequential display in accordance with an exemplary embodiment of the invention;

FIG. 22 is a diagram of a data structure of data stored in a recording/reproducing apparatus side of the exemplary embodiment of the invention;

FIGS. 23A and 23D are diagrams of display examples when execution of a part of the reproducing functions is made impossible in accordance with the exemplary embodiment of the invention;

FIG. 24 is a flow chart of a function of coping with a conventional application as an exemplary embodiment of the invention.

### DETAILED DESCRIPTION OF THE INVENTION

Hereinafter, exemplary embodiments of the present invention will be described in detail.

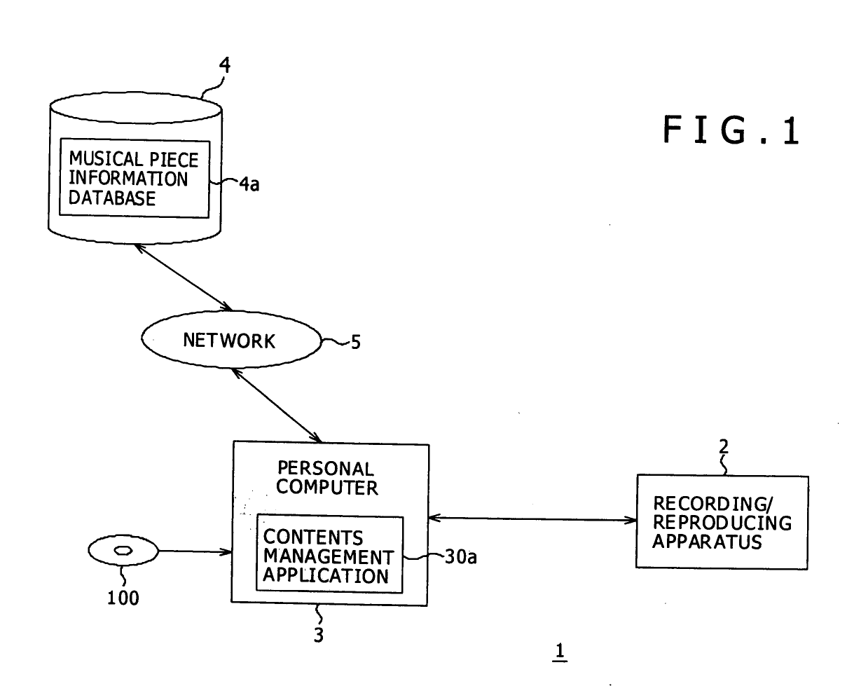

In the drawings, the same reference numerals are used for designating the same elements through the several figures. FIG. 1 is a block diagram of a recording/reproducing system 1 according to an exemplary embodiment of the present invention.

Referring to FIG. 1, the recording/reproducing system 1 of this embodiment includes at least a recording/reproducing apparatus 2, a personal computer 3, a server apparatus 4, a network 5, and an optical disc 100.

The exemplary recording/reproducing apparatus 2 is a portable device. In addition, a configuration in which a semiconductor memory, such as a flash memory, is utilized as a recording medium for.

In addition, the personal computer 3 is an information processor in the present invention and can make data communication with the recording/reproducing apparatus 2 through a Universal Serial Bus (USB) cable for example. In addition, the personal computer 3 can also make data communication with an external apparatus (the server apparatus 4) which is connected to the personal computer 3 through the network 5. Those skilled in the art will recognize that a variety of wireless and hard wire technology exist for effectuating the communications described herein, which are embraced by the present invention.

In operation, an application of the invention is discussed, such that in the recording/reproducing system 1 of this embodiment, contents data which is fetched from the optical disc 100 in the personal computer 3 is downloaded into the recording/reproducing apparatus 2 for reproduction.

In this case, it is assumed that the optical disc 100 is a music Compact Disc (CD), or like media, and the contents data is audio data.

While the details will be described later, application software (a contents management application 30a) for making the use form of the recording/reproducing system 1 of this embodiment possible is installed in the personal computer 3.

The exemplary contents management application 30a is an application for collectively managing the fetching of the contents data from the optical disc 100, the edit of the fetched contents data, and the downloading of the contents data into the recording/reproducing apparatus 2.

For example, the user can perform the fetching of the contents data from the optical disc 100 to the personal computer 3, the edit of the fetched contents data (e.g., the classification of the contents data in albums, the production of a playlist, the deletion of the contents data, etc.), and the like by activating the contents management application 30a to perform an operation in accordance with an instruction issued from the contents management application 30a.

In addition, the contents management application 30a is provided with a function of, when the recording/reproducing apparatus 2 is connected to the personal computer 3, downloading the contents data accumulated in the personal computer 3 side into the recording/reproducing apparatus 2 side in accordance with the operation.

In addition, the contents management application 30a is also provided with a function of compressing and encoding the contents data fetched from the optical disc 100 to record the resulting data in the recording/reproducing apparatus 2 by using a predetermined compression encoding system such as an Adaptive Transform Acoustic Coding (ATRAC) system or an MPEG Audio Layer 3 (MP3) system. In this way, more contents data can be recorded in the recording/reproducing apparatus 2.

Moreover, additive information of the contents, such as a musical name (track name), a recorded album name, and an artist name, which is fetched from the optical disc 100 can be acquired by the contents management application 30a.

Here, the additive information on the recorded music has been acquired based on the information extracted from the optical disc 100. For example, information on the number of tracks (the number of musical works), addresses of the tracks (absolute time information), the total musical performance time, etc. is recorded as Table Of Contents (TOC) data of the CD. While normally, that information becomes the same data in the CDs having the same title, it may be hardly occur that all the pieces of information agree with one another in the CDs having different titles. Consequently, the code specific to the CD title can be generated from the TOC data. Thus, a musical piece information database in which the additive information for each track of each title is stored in correspondence to the specific code is constructed, whereby the additive information on the recorded music can be acquired from the database based on the specific code generated from the CD as an object.

In this case, it is supposed that the musical piece information database is constructed in the server apparatus 4 connected to the network 5 as shown in the figure (the musical piece information database 4a in the figure). The contents management application 30a generates the above-mentioned specific code based on the TOC data in the installed optical disc 100 in accordance with an instruction to fetch the contents data from the installed optical disc 100. Then, an access is secured to the server apparatus 4 to refer to the musical piece information database 4a with the specific code as the retrieval condition, thereby acquiring the additive information corresponding to the contents data recorded in the installed optical disc 100.

After this, management information is generated so that the contents data fetched from the optical disc 100 and the acquired additional information are managed so as to be made to correspond to each other.

The technique for acquiring the additive information corresponding to the contents data recorded in the optical disc 100 from the musical piece information database in such a manner has already been well known, and thus a description of the detailed operation thereof is omitted in this specification.

In addition, in the exemplary embodiment, the description has been given with respect to the case where the musical piece information database 4a is structured in the server apparatus 4 connected to the personal computer 3 through the network 5. However, the musical piece information database 4a may also be constructed so that the personal computer 3 includes all of or a part of the musical piece information database 4a.

The contents data which is accumulated in the personal computer 3 side in the manner as described above and to which the additive information is made correspond is downloaded into the recording/reproducing apparatus 2 and recorded in the recording medium built in the recording/reproducing apparatus 2. As a result, the recording/reproducing apparatus 2 can reproduce the contents data recorded in the recording medium and also can display the additive information such as the track name, the album name and the artist name on the contents data.

Configuration of Information Processor

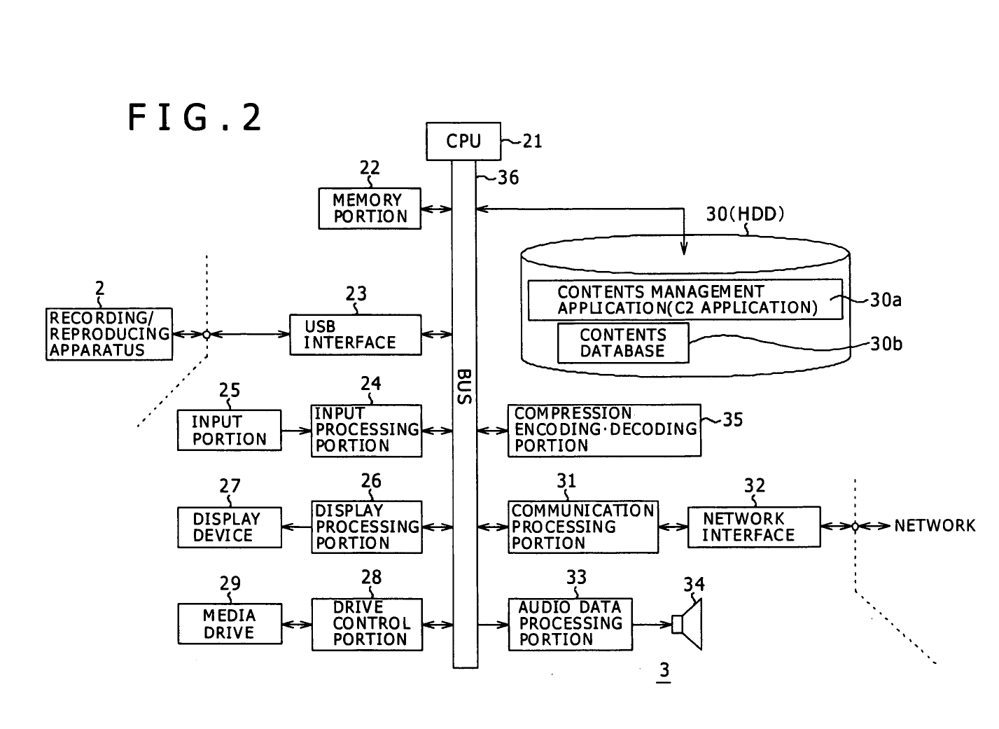

FIG. 2 is a high level block diagram showing an internal configuration of the personal computer 3 shown in FIG. 1.

Referring to FIG. 2, firstly, a CPU 21 performs the overall control and arithmetic operation processing of the personal computer 3 in accordance with an activated program. For example, the CPU 21 performs an input/output operation for a user, storage of a data file in an HDD 30, generation and update of management information, etc.

The CPU 21 makes an exchange of control signals and data with individual portions through a bus 36 shown in FIG. 2.

A memory portion 22 inclusively shows a ROM, a RAM, a flash memory and the like which the CPU 21 uses in executing the processing.

An operation program of the CPU 21, a program loader, and the like are stored in the ROM in the memory portion 22. In addition, various kinds of arithmetic operation coefficients, parameters used in the program, and the like are stored in the flash memory in the memory portion 22.

Moreover, a data area and a task area which are used when the program is executed are temporarily secured in the RAM in the memory portion 22.

A Universal Serial Bus (USB) interface 23 is provided in order that the personal computer 3 may make data communication with the external apparatus connected to the personal computer 3 through a USB cable. In particular, the various kinds of data such as the audio data are transmitted/received to/from the recording/reproducing apparatus 2 shown in FIG. 2 through the USB interface 23 in this case.

The storage of the data file, and the generation, update and the like of the management information are performed in the HDD 30 in accordance with the control made by the CPU 21 in the manner as described above.

For example, the contents data fetched from the optical disc 100 in the manner as described with reference to FIG. 1 is stored in the HDD 30. In addition, as has already been described too, the contents data in this case is managed in correspondence to the additive information acquired from the musical piece information database 4a. In such a manner, the contents management information used to manage the contents data is also recorded in the HDD 30. In this embodiment, the contents data and contents management information which are recorded in the HDD 30 are shown in the form of the contents database 30b.

In addition, a program (application) in accordance with which the personal computer 3 realizes the various kinds of functions is also stored in the HDD 30.

In particular, in the case of this embodiment, the contents management application 30a for managing the contents data in the manner described with reference to FIG. 1 as well is stored in the HDD 30. At that, the various kinds of function operations which are realized by the contents management application 30a will be described later.

An input portion 25 is a keyboard, a mouse, a remote commander, or any other suitable input device (not shown) which is provided in the personal computer 3. The user performs the various kinds of operation inputs or data inputs through the input portion 25. The information inputted through the input portion 25 is subjected to predetermine processing in an input processing portion 24 and transmitted as an input of the operation or data to the CPU 21. The CPU 21 performs the necessary arithmetic operation or control in correspondence to the information inputted thereto.

A media drive 29 is a drive function portion corresponding to a recording media such as an optical disc such as a CD, a Mini Disc (MD: magneto-optical disc), a CD-Recordable (CD-R), a CD-ReWritable (CD-RW), a Digital Versatile Disc (DVD), a DVD-R, or a DVD-RW, or a memory card (a semiconductor memory device as a removable media). The media drive 29 can perform a recording/reproducing operation about these media. For example, when the media drive 29 copes with a CD system disc media such as the optical disc 100 of this embodiment, the media drive 29, for example, is provided with an optical head, a spindle motor, a regenerative signal processing portion, a servo circuit, and the like.

A drive control portion 28 controls a recording/reproducing operation, an access operation, and the like about the media installed in the media drive 29. For example, when the user performs a reproducing operation for the media installed in the media drive 29 through the input portion 25, the CPU 21 instructs the drive control portion 28 to reproduce the media. Then, the drive control portion 28 performs the control for instructing the media drive 29 to carry out an access operation and a reproducing operation. The media drive 29 sends the read-out reproduced data to the bus 36 through the drive control portion 28.

An audio data processing portion 33 subjects the audio data inputted thereto to sound field processing or sound volume adjustment such as equalizing, and processing such as D/A conversion and amplification in accordance with the control made by the CPU 21 and outputs the resulting data to the outside through a speaker portion 34.

For example, when the audio data read out by the media drive 29, or the audio data (contents data) stored in the HDD 30 is reproduced, the audio data is processed in the audio data processing portion 33 and the resulting data is then outputted to the outside through the speaker portion 34.

Incidentally, the contents data stored in the contents database 30b within the HDD 30 is compressed and encoded by using the predetermined compression and encoding system in some cases. In such cases, after the compressed and encoded data is decoded in a compression encoding decoding portion 35 which will be described later, the resulting data is supplied to the audio data processing portion 33.

A display device 27 is one such as a liquid crystal panel, and displays thereon the various kinds of information for the user.

For example, when the CPU 21 supplies the display information to a display processing portion 26 in correspondence to the various kinds of operation states, input states and communication states, the display processing portion 26 drives the display device 27 based on the display data supplied thereto to instruct the display device 27 to perform the display operation.

In addition, when the video data is reproduced from the media installed in the media drive 29 or from the HDD 30, the display processing portion 26 executes the signal processing for the reproduced data, and drives the display device 27 based on the resulting signal to instruct the display device 27 to perform the video display.

A communication processing portion 31 executes encoding processing for transmission data and decoding processing for received data in accordance with the control made by the CPU 21.

A network interface 32 transmits the transmission data which is encoded in the communication processing portion 31 to the predetermined apparatus, e.g., the server apparatus 4 through the network 5 shown in FIG. 1. In addition, the network interface 32 delivers the signal which is transmitted thereto from the external apparatus such as the server apparatus 4 through the network 5 to the communication processing portion 31.

The communication processing portion 31 transfers the received information to the CPU 21.

The compression encoding decoding portion 35 compresses and encodes the audio data transmitted thereto by using the predetermined compression encoding system, and executes the decoding processing for the audio data which is compressed and encoded by using the predetermined compression encoding system.

While the compression encoding decoding portion 35 is structured in the form of hardware in this embodiment, the operation of the compression encoding decoding portion 35 may be realized by executing software processing in the CPU 21.

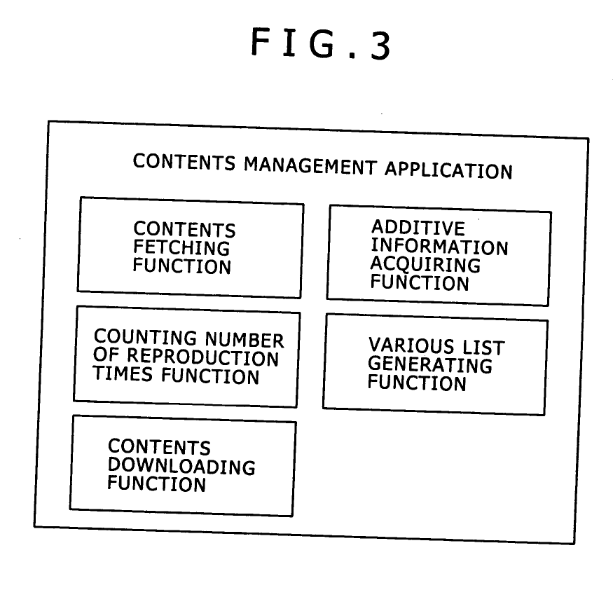

At that, the configuration of the personal computer 3 is not limited to one shown in FIG. 3, and thus the various kinds of configurations may also be adopted.

For example, a configuration may be adopted which includes a terminal for use in connection of a microphone or an external headphones, a video I/O terminal corresponding to the recording/reproduction in the DVD, a line connection terminal (Sony/Phillips Digital Interface), an SPDIF terminal, and the like.

Function of Contents Management Application

FIG. 3 shows functions which are realized by the contents management application 30a shown in FIG. 2. It should be noted that in the figure, of the functions realized by the contents management application 30a, the functions relating to realization of the operation in terms of this embodiment are shown, and any of other functions is omitted here.

As shown in the figure, a contents fetching function, an additive information acquiring function, a function of counting the number of the reproduction times, a function of generating the various kinds of lists, and a contents downloading function are provided as the main functions realized by the contents management application 30a.

The contents fetching function is a function of fetching the contents data recorded in the optical disc 100 in the HDD 30.

That is, as the contents fetching function, the CPU 21 instructs the drive control portion 28 to read out the contents data from the optical disc 100 in response to that the optical disc 100 is installed in the media drive 29, and an instruction to fetch the contents data from the optical disc 100 is issued. In this connection, after supplying the data read out from the optical disc 100 in accordance with the instruction to the compression encoding decoding portion 36 and subjecting the data to the compression encoding decoding processing, the CPU 21 issues an instruction to record the resulting data in the HDD 30.

In addition, it is supposed that as the contents fetching function, a track of which is to be fetched is selected from among the contents data which is recorded in pieces of music (in tracks) in the optical disc 100.

The additive information acquiring function, for example, is a function of acquiring the additive information of the contents data from the musical piece information database 4a within the server apparatus 4 connected to the personal computer 3 through the network 5 as shown in FIG. 1 and of managing the additive information thus acquired in correspondence to the recorded contents data.

In acquiring the additive information, the CPU 21 generates the specific code as previously described based on the TOC data (the number of tracks (the number of pieces of music), addresses of the tracks (absolute time information), and the total musical performance time) in the installed optical disc 100 in accordance with an instruction to fetch the contents data in the installed optical disc 100, and the like.

In addition, along with this, the CPU 21 instructs the communication processing portion 31 to establish the connection with the server apparatus 4.

As previously stated too, the additive information on the tracks which are recorded in the CDs having the titles in correspondence to the specific code of the respective titles is stored in the musical piece information database 4a. The CPU 21 transmits the command together with the specific code to the server apparatus 4 the connection to which is established, thereby issuing an instruction to refer to the musical piece information database 4a with the specific code as the retrieval condition. In response thereto, the additive information for each track stored in the musical piece information database 4a in correspondence to the specific code is sent as reply from the server apparatus 4 side. As a result, the personal computer 3 acquires the additive information corresponding to the respective contents data recorded in the installed optical disc 100.

After this, the CPU 21 generates (or updates) the contents management information so that the contents data (respective tracks) fetched from the optical disc 100 by the contents fetching function and the acquired additive information are managed so as to made correspond to each other, thereby managing the contents data.

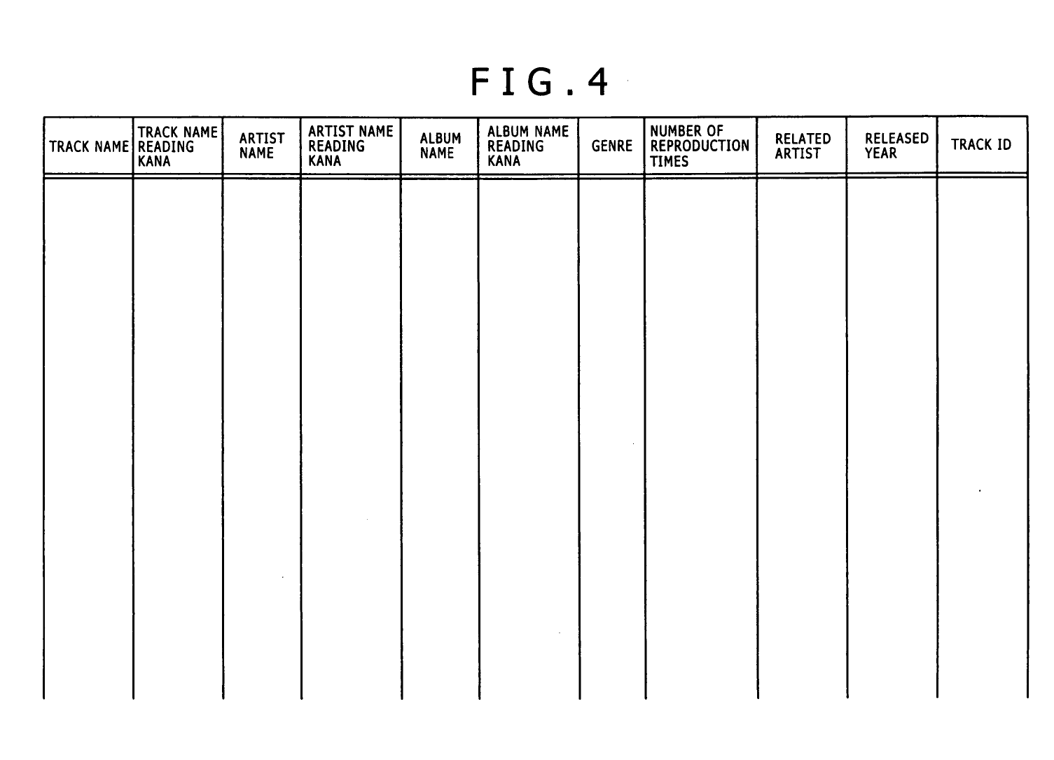

FIG. 4 conceptually shows a data structure of the contents management information generated in this case.

As shown in FIG. 4, as regards the additive information which is to be made correspond to the respective contents data in this embodiment, there are a plurality of information on a track name, a reading kana of a track name, an artist name, a reading kana of an artist name, an album name, a reading kana of an album name, a genre, the number of reproduction times, a released year, and a related artist.

Of them, the individual information other than “the number of reproduction times” becomes the additive information which is acquired from the musical piece information database 4a in the manner as described above. Incidentally, the information on “the number of reproduction times” is one which is generated in the personal computer 3 by the function of counting the number of the reproduction times as will be described later. The information on “the number of reproduction times” will be described later.

In FIG. 4, “track name” is information which is to be made correspond to the contents data forming one track, and is information on a title of a musical piece which is performed by reproducing the contents data thereof.

In addition, “reading kana of track name” is information which is used when the information on the track names is sorted in the order of the Japanese syllabary, and is information in which the reading of the track name is described with Cursive Japanese characters or katakana characters. Incidentally, in the following items as well, “reading kana” becomes information in which the reading of the individual items is described with Cursive Japanese characters or katakana characters.

In addition, “artist name” is name information on an artist who sings, plays, composes, writes the words of, and produces the musical piece as the track. Also, “album name” is a name of a music album (a single in some cases) in which the musical piece concerned is recorded.

Moreover, “genre” is information representing a name of a musical genre (e.g., pops music, rock music, jazz music, a popular song with a melody of traditional Japanese type, etc.) to which the musical piece concerned belongs. “Released year” is information on a year when the musical piece concerned was released (put on the market).

In addition, “related artist” is name information on an artist who is determined as being related to the artist concerned.

For example, when a certain artist name called “A” is a name of a band and individual members of the band called “A” release as solos as well a CD to the customers, the names of these members may become the information on the related artist of the band called “A”.

In addition, when an artist called “C” released his/her CD in the past under the production by an artist called “D”, and the artist himself/herself, called “D”, who produced the CD also released his/her CD to the customers in the past, the name “D” of the artist may become the information on the related artist of the artist “C”.

The CPU 21 generates the contents management information such that the information on a contents ID is made correspond to these pieces of additive information in the manner as shown in the figure.

The contents ID is an identifier which is used to uniquely identify the contents data as the tracks stored in the HDD 30a. That is, the correspondence between the tracks and these pieces of additive information is realized based on such correspondence.

At that, it is supposed that in this embodiment, the information on these “reading kanas” is acquired from the musical piece information database 4a. However, the information on these “reading kanas” may also be generated on the personal computer 3 side based on these pieces of the information on the track name, the artist name, and the album name.

For example, if dictionary data is used in which the information on the reading kanas about the track name, the artist name, and the album name is previously stored, the personal computer 3 can acquire the information on the reading kanas about these items.

Referring back to FIG. 3, the function of counting the number of reproduction times is a function of counting the number of times by which the contents data is reproduced and of making the information on the number of the reproduction times correspond as the additive information on the contents data to the contents ID of the contents data.

As the function of counting the number of reproduction times, the CPU 21 executes the processing of, whenever the contents data stored in the HDD 30 is reproduced, increasing a value of the number of the reproduction times which is made correspond to the contents ID of the contents data in the contents management information shown in FIG. 4.

As a result, the number of the reproduction times of the contents data is managed.

Incidentally, while the information on the number of the reproduction times is used as an index for guessing which music a user usually listens to by taste, at this time, there is the possibility that the results which do not cover the user's taste are obtained depending on how to define the reproduction. For example, if it is contained in “reproduction” that the contents data is reproduced even in an instant, even the music which is actually listened and judged not to be taste to be skipped by the user is treated as being “reproduced”. Thus, in this respect, that information may not be treated as information to which the user's taste is truly reflected. In consideration of this respect, it is preferable that a device is made to truly reflect the user's taste to that information in such a manner that the fact that the music is not skipped over equal to or longer than a predetermined period of time is made the condition for “reproduction” in the function of counting the number of reproduction times, and so forth.

In addition, as for the function of counting the number of reproduction times, the number of the reproduction times may be not only increased, but also decreased. For example, the music which is skipped within a predetermined period of time may be regarded as being judged not to be taste by the user, and a value of the number of the reproduction times of that music may be decreased by a predetermined value.

In addition, in FIG. 3, the function of generating various kinds of lists is a function of generating the various kinds of lists required to realize the various kinds of reproducing functions in the reading/reproducing apparatus 2 which will be described later.

In this case, an order list for reproduction times, an artist link list, a released year list, and a playlist are generated as the various kinds of lists.

Of them, the playlist, as previously stated, is a list with one or a plurality of tracks arbitrarily selected by the user as a unit. That is to say, the playlist is a list which the user manually issues an instruction to generate.

On the other hand, each of other lists is a list which is automatically generated by the contents management application 30a in order to be submitted for realization of the various kinds of reproducing functions in the recording/reproducing apparatus 2 which will be described later.

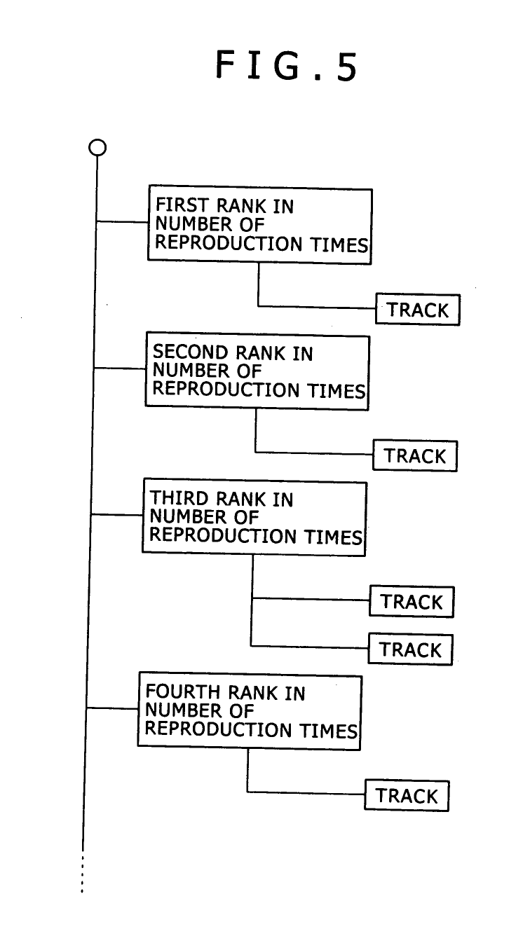

Firstly, the order list for reproduction times is a list which is obtained by sorting the tracks in the order of the number of the reproduction times in a manner as shown in FIG. 5. That is to say, the tracks can be managed in the order of decreasing the number of the reproduction times by this list.

In generating the order list for reproduction times, the CPU 21 generates the list which is obtained by sorting the track names and the information on the contents ID made to correspond thereto in the order of decreasing the number of the reproduction times based on the contents management information shown in FIG. 4. The order list for reproduction times which is generated in such a manner, for example, is stored in the HDD 30.

In addition, the artist link list is a list which is used when the reproduction is performed with all the tracks (pieces of music) of a certain artist and a predetermined related artist who is regarded as being related to this artist as one reproduction object range. For example, making reference to the previous example, all the tracks of the artist “A” as the band and all the tracks of the individual members of that band are regarded as the reproduction object range, and under this condition the reproduction is performed.

The artist link list is generated such that a unit by “the artist+the related artist” as described above is formed every artist name. The list is generated in the manner as described above and a certain artist is selected in a manner as will be described later, whereby it is possible to select the unit by the certain artist and the related artist.

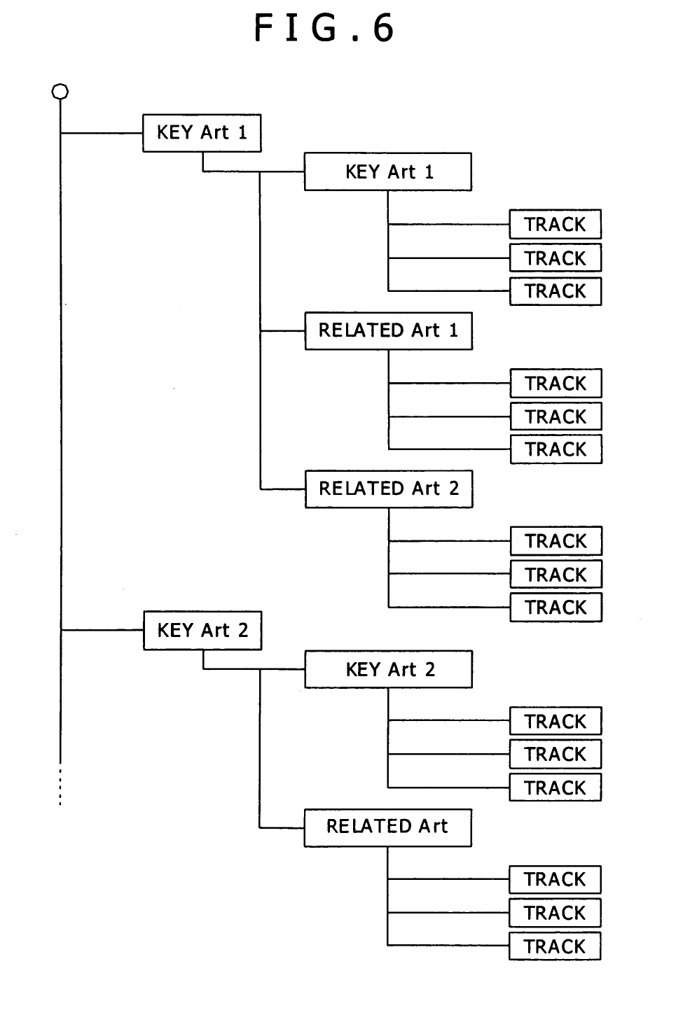

FIG. 6 shows a structure of such an artist link list.

In the figure, “key Arts” (“Art” is an abbreviated name of an artist) represented by key Art1, key Art2, etc. become information on “artist names” in the contents management information shown in FIG. 4. In other words, the information on all artist names existing within the contents management information shown in FIG. 4 is arranged in a first hierarchy in this artist link list.

It should be noted that as described above too, the artist link list is generated so that selecting a certain artist makes it possible to select a unit by the certain artist and the related artist. In this meaning, in this embodiment, the information on the artist name ranked in the first hierarchy is represented by “key Art”.

Information on the key Art and information on a related artist of the key Art (related Art) are arranged every key Art ranked in the first hierarchy in a second hierarchy next to the first hierarchy in which the information on the individual artist names as the key Art is arranged. That is, the information on the artist names as key Art in the first hierarchy, and the information which is stored as “related artist” in correspondence to the information on that artist name in the contents management information shown in FIG. 4 are arranged in the second hierarchy.

Moreover, information on track names to which the artist name is made correspond is arranged every artist name in the second hierarchy in a third hierarchy. In other words, the information on the track names in which the information on the artist name is stored as “artist name” in the contents management information shown in FIG. 4 is arranged every artist name as key Art or related Art in the second hierarchy in the third hierarchy.

As a function of generating the artist link list, the CPU 21 acquires the information on all the artist names existing in the contents management information shown in FIG. 4 as the information on key Art which is previously stated. Moreover, the CPU 21 acquires the information on the related artist from the contents management information every artist name as key Art, and makes the information on the artist name and the acquired information on the related artist correspond to each other every information on the artist name as key Art ranked in the first hierarchy (second hierarchy). After this, the CPU 21 acquires the information on “track name” to which the name information is made correspond as the information on “artist name” every information on the artist name and the related artist which are made correspond to key Art in the first hierarchy in such a manner and makes these pieces of the information on the track names correspond to the artist names and the related artists (third hierarchy).

At that, it is supposed that for some artists, there is no information on the related artist. In this case, the list may be generated in which the second hierarchy includes the artist name of key Art.

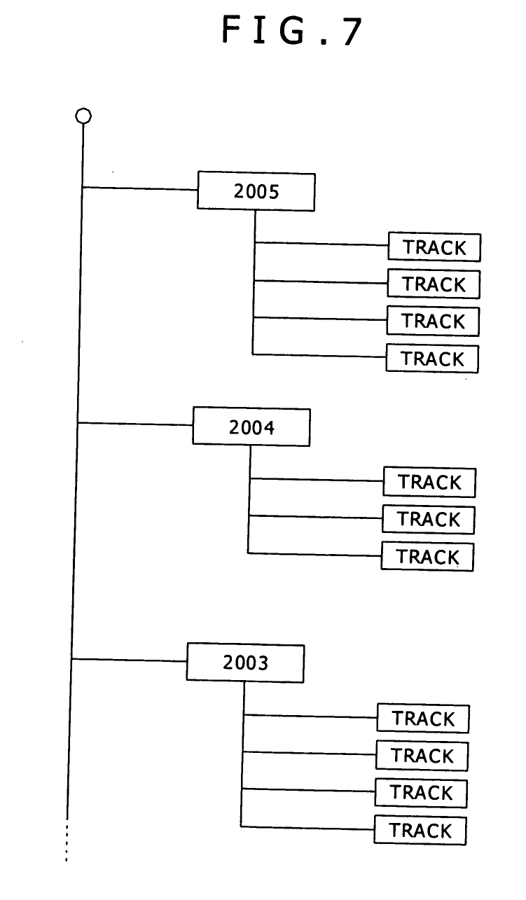

In addition, the released year list is a list which is obtained by sorting the tracks by released year in the manner as shown in FIG. 7.

As a function of generating the released year list, the CPU 21 acquires the information on the track name having the information on the released year as the additive information every information on each released year existing in the contents management information shown in FIG. 4, and generates a list in which the acquired information on the track name is made correspond to the released year every information on each released year.

The tracks can be managed by released year based on such a released year list.

In addition, in FIG. 3, a contents downloading function is a function of downloading the contents data and the contents management information which are stored as the contents database 30b in the HDD 30, and the various kinds of lists (the order list for reproduction times, the artist link list, and the released year list) described with reference to FIGS. 5 to 7 into the recording/reproducing apparatus 2 shown in FIG. 1.

As the contents downloading function, the CPU 21, in a state in which it is connected to the recording/reproducing apparatus 2 side through the USB cable so that it can make data communication with the recording/reproducing apparatus 2 through the USB interface 23 shown in FIG. 2, sequentially reads out the contents data, the contents management information, and the information on the various kinds of lists which are stored in the HDD 30, transfers the contents data, the contents management information, and the information on the various kinds of lists to the recording/reproducing apparatus 2 side through the USB interface 23, and issues an instruction to read such information.

As a result, the information required to reproduce the contents data is downloaded into the recording/reproducing apparatus 2 side.

Incidentally, when the information is previously downloaded from the personal computer 3 side into the recording/reproducing apparatus 2, and so forth, the personal computer 3 has to download the contents data added to the HDD 30 from the last download phase and its additive information into the recording/reproducing apparatus 2. In this case, the information which is updated in its contents in correspondence to the additive information for the added contents data is downloaded as the information on the various kinds of lists into the recording/reproducing apparatus 2 side.

In addition, as the contents downloading function, of all the tracks stored in the HDD 30, the selected track can be downloaded into the recording/reproducing apparatus 2 side. In this case, the management information on the selected track is downloaded as the contents management information shown in FIG. 4 into the recording/reproducing apparatus 2 side. In addition, the various kinds of lists having the selected track as an object are downloaded into the recording/reproducing apparatus 2 side.

Also, in this case, as the contents downloading function, it is supposed that all the contents data to be downloaded into the recording/reproducing apparatus 2 is downloaded in a state of being compressed by using the predetermined compression encoding system.

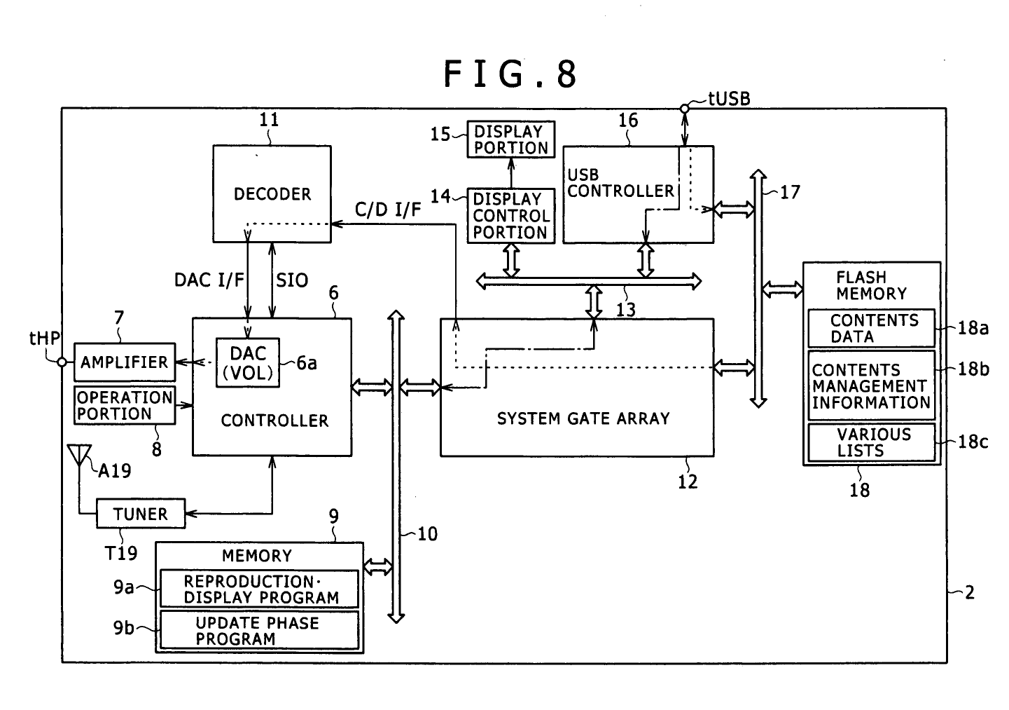

FIG. 8 is a block diagram showing an internal configuration of the recording/reproducing apparatus 2 shown in FIG. 1.

The recording/reproducing apparatus 2 is provided with a flash memory 18, shown in the figure, as a recording medium for storing therein the contents data or the like downloaded from the personal computer 3 into the recording/reproducing apparatus 2. In this case, it is supposed that the storage capacity of the flash memory 18, for example, is in the range of about several hundred megabytes (MB) to about several gigabytes (GB).

In addition, the recording/reproducing apparatus 2 is provided with a tuner T19 and an antenna A19, shown in the figure, together with a function of reproducing the contents data stored in the flash memory 18. Thus, the reception and selection of a Frequency Modulation (FM) broadcasting can be made.

In FIG. 8, a controller 6 is configured in the form of a microcomputer including a ROM, a RAM, and a CPU, and performs the control and arithmetic operation for the overall recording/reproducing apparatus 2 in accordance with an activated program. For example, the controller 6 performs the control or the like for an input/output operation for the user, and the recording/reproduction of the contents data in/from the flash memory 18.

In addition, in this case, the controller 6 includes a D/A conversion function in a D/A converter (DAC) 6a shown in the figure, and a function of adjusting sound volume.

An amplifier 7, an operation portion 8, and the tuner T19 are connected to the controller 6.

The amplifier 7 inputs audio data for which the controller 6 performs the D/A conversion and the sound volume adjustment by using the D/A function and the sound volume adjusting function in the DAC 6a, amplifies the audio data, and supplies the resulting data to a headphones terminal tHP shown in the figure.

In addition, the operation portion 8 is provided with various kinds of operation portions which are provided so as to project to the outside of a chassis of the recording/reproducing apparatus 2 concerned. When inputted an operation signal corresponding to the various kinds of operation portions, the controller 6 controls the portions required to obtain the operation corresponding to the operation signal. As a result, the user can instruct the recording/reproducing apparatus 2 to perform the various kinds of operations by performing the operation for the various kinds of operation portions included in the operation portion 8.

In addition, the tuner T19 executes reception broadcasting selection processing with respect to the FM broadcasting signal inputted through the antenna A19 shown in the figure, and supplies the resulting audio signal to the controller 6. The controller 6 performs the sound volume adjustment for the audio signal supplied thereto from the tuner T19 in such a manner, and supplies the resulting signal to the amplifier 7.

In addition, a memory 9 is connected to the controller 6 through a first bus 10 shown in the figure. The memory 9 is a non-volatile memory such as a flash memory. Coefficients used in the various kinds of arithmetic operations of the controller 6, parameters used in the program, and the like are stored in the memory 9.

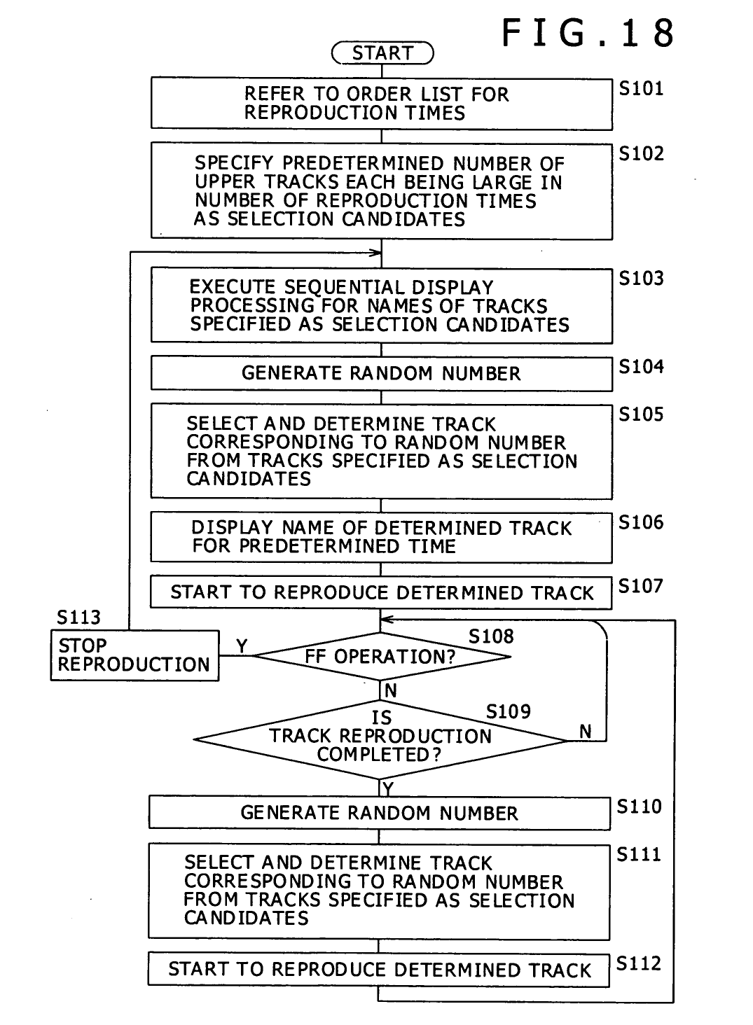

In particular, in the case of this embodiment, a reproduction display program 9a in accordance with which the controller 6 executes processing operations which will be described later with reference to FIGS. 18 to 20 is stored in the memory 9. In addition, in the case of this embodiment, an update phase program 9b in accordance with which the controller 6 executes a processing operation which will be described later with reference to FIG. 26 is also stored in the memory 9.

It should be noted that the reproduction display portion 9a, and the update phase program 9b may also be stored in the flash memory 18 or in a ROM, etc. provided inside the controller 6.

In addition, a decoder 11 is connected to the controller 6 through a DAC I/F and an SIO shown in the figure.

The decoder 11 executes processing for decoding the audio data which is compressed and encoded by using the predetermined compression encoding system. Also, the decoder 11 also executes audio signal processing such as surround processing for the audio data which is obtained in the decoding processing.

The audio data outputted from the decoder 11 is supplied to the controller 6 through the DAC I/F, and supplied to the amplifier 7 after being subjected to the D/A conversion processing and the sound volume adjusting processing in the DAC 6a by the controller 6, and then supplied to the headphones terminal tHP.

Incidentally, the controller 6 issues the various kinds of control instructions for the decoder 11 through the SIO shown in the figure.

In addition, a system gate array 12 is connected to the controller 6 through the first bus 10. The system gate array 12 is a Large Scale Integration (LSI) for performing the control for transfer of the various kinds of data such as the audio data and the commands to the respective portions.

The system gate array 12 is connected to the decoder 11 through the C/D I/F shown in the figure. In addition, the system gate array 12 is connected to a display control portion 14, and a USB controller 16 through a second bus 13 and also connected to the flash memory 18 through a third bus 17.

A display portion 15 is a display device such as an organic Electro Luminescence (EL) display or a liquid crystal display, and displays thereon the various kinds of information for the user.

The display control portion 14 drives the display portion 15 to cause the display portion 15 to perform a display operation based on display data supplied thereto from the controller 6 through the first bus 10, the system gate array 12, and the second bus 13.

The USB controller 16 is provided in order to make data communication with the external apparatus (the personal computer 3 in this embodiment) connected to the recording/reproducing apparatus 2 through a USB cable connected to the USB terminal tUSB shown in the figure. That is to say, the USB controller 16 makes the data communication with the external apparatus by executing processing for encoding the transmission data and processing for decoding received data in accordance with the USB communication system.

At that, it is supposed that the recording/reproducing apparatus 2 of this embodiment corresponds to a USB mass storage class (MSC). As a result, when being connected to the personal computer 3 side through the USB cable, the recording/reproducing apparatus 2 is recognized as an outside storage apparatus on the personal computer 3 side.

Here, as understood from the description until now, the contents data transferred from the personal computer 3 side is inputted to the recording/reproducing apparatus 2 side through the USB controller 16.

When receiving the contents data from the personal computer 3 side, the USB controller 16 directly transfers the contents data received thereat to the flash memory 18 through the third bus 17 to cause the flash memory 18 to perform the operation for writing the contents data. That is to say, the contents data transferred from the personal computer 3 side is recorded in the flash memory 18 in accordance with the control made by the USB controller 16.

In addition, the USB controller 16 writes the contents management information, and the information on the various kinds of lists (the order list for reproduction times, the artist link list, the released year list, and the playlist) which are transferred from the personal computer 3 side to the flash memory 18 through the same route as that for the contents data.

In FIG. 8, the contents data, the contents management information, and the information on the various kinds of lists which are stored in the flash memory 18 in such a manner are shown in the form of contents data 18a, contents management information 18b, and the various lists 18c in the manner as shown in the figure, respectively.

In addition, when the contents data is downloaded into the recording/reproducing apparatus 2, a command is also transferred from the personal computer 3. The USB controller 16 transfers such a command from the personal computer 3 side to the USB controller 16 through the second bus 13, the system gate array 12, and the first bus 10 so that the controller 6 interprets the contents of the command. The controller 6 executes necessary processing in correspondence to the interpreted contents of the command.

Also, during the reproduction of the contents data 18a recorded in the flash memory 18, the contents data (compressed and encoded audio data) read out from the flash memory 18 is inputted to the system gate array 12 through the third bus 17 in accordance with an instruction issued from the controller 6. Then, the system gate array 12 supplies the compressed and encoded audio data as the input contents data to the decoder 11 through the C/D I/F. The decoder 11 executes the processing for decoding the compressed and encoded audio data to obtain audio data, subjects the audio data to predetermined audio signal processing, and supplies the resulting audio data to the controller 6 through the DAC I/F.

The controller 6 subjects the audio data supplied thereto to the D/A conversion processing and the sound volume adjusting processing in the DAC 6a and supplies the resulting audio data to the amplifier 7. The audio data supplied to the amplifier 7 is amplified and supplied to the headphones terminal tHP.

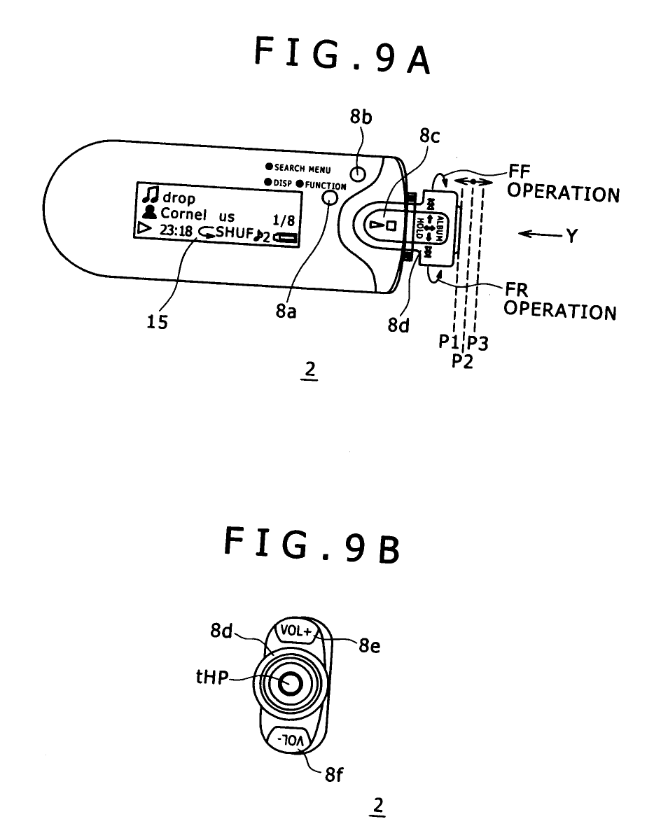

In addition, FIGS. 9A and 9B show external views of the recording/reproducing apparatus 2 and explaining the main operation portions included in the operation portion 8 shown in FIG. 8.

In FIGS. 9A and 9B, FIG. 9A shows a front view of the recording/reproducing apparatus 2, and FIG. 9B shows a view of the recording/reproducing apparatus 2 when viewed from a Y direction in FIG. 9A.

Incidentally, the display portion 15 described with reference to FIG. 8 is also shown in FIG. 9A. Thus, the display portion 15 is provided so as to be exposed to the outside of the chassis of the recording/reproducing apparatus 2. In this case, the headphones terminal tHP shown in FIG. 8 is provided at a center portion of a shuttle switch 8d as shown in FIG. 9B.

The recording/reproducing apparatus 2 is provided with a DISP/FUNC key 8a, a SEARCH/MENU key 8b, a PLAY/STOP key 8c, the shuttle switch 8d, a VOL+ key 8e, and a VOL− key 8f in the manner as shown in FIGS. 9A and 9B.

The DISP/FUNC key 8a is an operation portion for issuing an instruction to change the display information on the display device as the display portion 15, and an instruction to change the various kinds of reproducing functions of the recording/reproducing apparatus 2 which will be described later.

In addition, the SEARCH/MENU key 8b is an operation portion for issuing an instruction to call a search mode in which the desired contents data is searched in albums, in tracks, etc. from among the contents data stored in the flash memory 18, and an instruction to call a menu screen for the various kinds of settings.

The PLAY/STOP key 8c is an operation portion for issuing an instruction to start/stop the reproduction of the contents data, and an instruction to determine the various kinds of selection items.

The shuttle switch 8d is an operation portion which can make a slide operation for three positions P1, P2 and P3 (three-slide operation) shown in FIG. 9A, and a rotation operation for two directions indicated by curved arrows in FIG. 9A, respectively.

As for the rotation operation of the shuttle switch 8d, a rotation operation for one rotation direction is an FF operation. An instruction to skip the track being reproduced, an instruction to forward feed the various kinds of selection items, etc. become possible by performing the FF operation. In addition, the rotation operation for the other rotation direction is an FR operation. A heading instruction for the track being reproduced, a backwardly feeding instruction for the various kinds of selection items, an instruction to backward feed the various kinds of selection items, etc. become possible by performing the FR operation.

In addition, as for the three-slide operation of the shuttle switch 8d, the position P1 shown in FIG. 9A corresponds to a HOLD instruction. When the shuttle switch 8d is slid to the position P1, the recording/reproducing apparatus 2 is in a state in which all the operation inputs cannot be accepted.

In addition, the position P2 is a neutral position. When the shuttle switch 8d is in the position P2 and the reproduction is being performed, the instruction to skip the track being reproduced is issued by performing the FF operation, and the heading instruction for track being reproduced is issued by performing the FR operation.

Incidentally, in the following description, the position P2 will be referred to as a track position as well.

Also, the position P3 is an album position. When the shuttle switch 8d is slid to the album position P3 and the reproduction is being performed, the instruction to skip the tracks in albums (or in playlists) is issued by performing the FF operation. In other words, there is issued an instruction to perform the forward feeding to a head track of an album which is previously determined to be reproduced next to an album to which the track being reproduced belongs. In addition, the FR operation in this case is a backward feeding operation which is performed in albums (in playlists). That is, an instruction to perform the backward feeding to the head track of the album which is determined in terms of the reproduction order to be the front of the album to which the track being reproduced belongs is issued by performing the FR operation.

Also, in FIG. 9B, the VOL+ key 8e and the VOL− key 8f are operation portions for the sound volume adjusting instruction. The VOL+ key 8e is the operation portion for issuing an instruction to increase the sound volume, while the VOL− key 8f is an operation portion for issuing an instruction to decrease the sound volume.

Reproducing Functions of Recording/Reproducing Apparatus

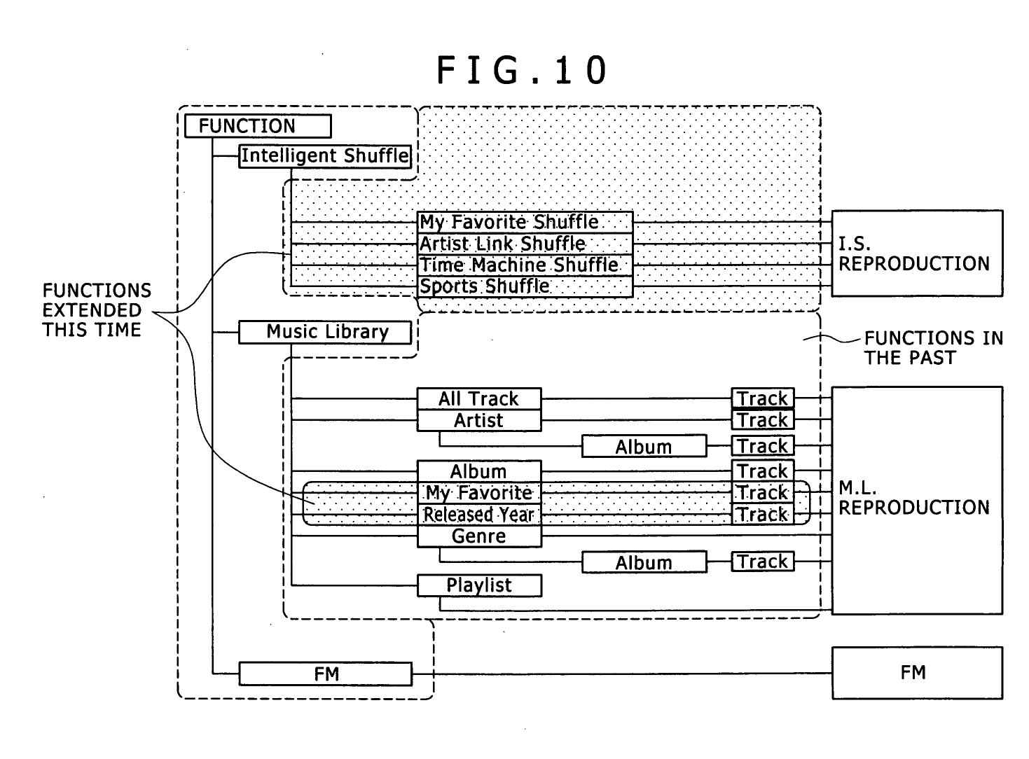

FIG. 10 is a diagram explaining the various kinds of reproducing functions which the recording/reproducing apparatus 2 of this embodiment has.

Firstly, the reproducing functions which the recording/reproducing apparatus 2 has are roughly classified into an Intelligent Shuffle reproducing function, a Music Library reproducing function, and an FM reproducing (receiving) function.

At that, in the figure, the Intelligent Shuffle reproducing function, the Music Library reproducing function, and the FM reproducing (receiving) function are arranged in a hierarchy under an item of “Function”. This means that in using the recording/reproducing apparatus 2, the user uses the recording/reproducing apparatus 2 so as to select a desired function from among the three reproducing functions.

As will be described later, the user performs an operation for long depressing the DISP/FUNC key 8a shown in FIG. 9A, thereby displaying a selection screen with which the desired function is selected from the Intelligent Shuffle reproducing function, the Music Library reproducing function, and the FM reproducing (receiving) function. The user determines any one of the reproducing (receiving) functions from the selection screen.

In FIG. 10, four shuffle reproducing functions, i.e., a My Favorite Shuffle reproducing function, an Artist Link Shuffle reproducing function, a Time Machine Shuffle reproducing function, and a Sports Shuffle representing function are prepared for the Intelligent Shuffle reproducing function in the manner as shown in the figure.

The My Favorite Shuffle reproducing function is a reproducing function of performing shuffle reproduction with a predetermined number of upper tracks each being large in number of the reproduction times as objects of the reproduction.

The order list for reproduction times which is downloaded from the personal computer 3 side into the recording/reproducing apparatus 3 side as previously stated is used in the My Favorite Shuffle reproducing function.

In addition, the Artist Link Shuffle reproducing function is a reproducing function of performing the shuffle reproduction with all the tracks of the specified artist and the related artist as objects of the reproduction. Likewise, the artist link list which is downloaded from the personal computer 3 side into the encoding/reproducing apparatus 2 side is used in the Artist Link Shuffle reproducing function.

In addition, the Time Machine Shuffle reproducing function is a reproducing function of performing the shuffle reproduction with all the tracks in the specified released year as objects of the reproduction. The released year list is used in the Time Machine Shuffle reproducing function.

Also, the Sports Shuffle reproducing function is a function of, in performing the shuffle reproduction with all the tracks as objects of the reproduction, automatically stopping the shuffle reproduction after a lapse of a set period of time. That is to say, the Sports Shuffle reproducing function is a shuffle reproducing function with an auto off timer function.

Here, it is supposed that the portable type recording/reproducing apparatus 2 is used in the application on which the user enjoys the music while carrying the recording/reproducing apparatus 2 during a jog for example. The user can be informed of that he/she has performed a jog or the like for a set period of time based on stop of the reproduced sound as long as there is provided the auto off timer function as the Sports Shuffle reproducing function.

Incidentally, giving a description for confirmation, “the shuffle reproduction” stated herein means that the reproduction is performed so as to give the order of the reproduction of the music (tracks), or selection of predetermined candidate information irregularly by using the random sampling numbers.

In addition, in the following description, for the sake of convenience, the Intelligent Shuffle reproduction is abbreviated as “I.S. reproduction” in some cases.

Subsequently, as shown in FIG. 10, an All Track reproducing function, an Artist reproducing function, an Album reproducing function, a My Favorite reproducing function, a Released year reproducing function, a Genre reproducing function, and a Playlist reproducing function are prepared for the Music library reproducing function.

No shuffle reproduction is performed in the Music Library reproducing function.

At that, the Music Library reproducing function will also be referred to as “M.L. reproduction” in the following description.

The All Track reproducing function is a reproducing function of performing the reproduction with all the tracks as objects of the reproduction.

In addition, the Artist reproducing function is a function of performing the reproduction with all the tracks of the specified artist, or all the tracks within the specified album when there are a plurality of albums of the specified artist as objects of the reproduction.

Also, the Album reproducing function is a function of performing the reproduction with all the tracks within the specified album as objects of the reproduction.

The My Favorite reproducing function is a reproducing function of performing the reproduction with a predetermined number of upper tracks each being large in number of the reproduction times as objects of the reproduction. Similarly to the My Favorite reproducing function, the order list for reproduction times is used in the My Favorite reproducing function as well.

In addition, the Released year reproducing function is a reproducing function of performing the reproduction with all the tracks in the specified released year as objects of the reproduction. Similarly to the Time Machine Shuffle reproducing function, the released year list is used in the Released year reproducing function.

In addition, the Genre reproducing function is a function of performing the reproduction with all the tracks of the same genre, or all the tracks within the specified album when there are a plurality of albums of the same genre as objects of the reproduction.

In addition, the Playlist reproducing function is a function of performing the reproduction with all the tracks within the specified playlist as objects of the reproduction.

The FM receiving function is a function of receiving and selecting the FM broadcasting to output the sound thereof.

Here, of the various kinds of reproducing (receiving) functions, the Intelligent Shuffle (I.S.) receiving function and a part of the Music Library (M.L.) reproducing function (the My Favorite reproducing function and the Released year reproducing function) which are represented by a shaded portion in the figure are functions which are extended in the present recording/reproducing apparatus 2. In other words, the M.L. reproducing function (All Track, Artist, Album, Genre, and Playlist reproducing functions) other than the reproducing functions represented by the shaded portion, and the FM receiving function are the functions in the past.

Since the present functions are extended in the manner as described above, the contents management application 30a on the personal computer 3 side is also extended in function from the contents management application which copes with the apparatus in the past.

More specifically, the function of generating the various kinds of lists shown in FIGS. 5 to 7 is added to the present contents management application 30a. These lists are generated and downloaded into the recording/reproducing apparatus 2 side in the manner as described above, whereby the I.S. reproducing function and a part of the M.L. reproducing function are extended this time can be realized in the recording/reproducing apparatus 2.

Conversely speaking, in the recording/reproducing system in the past, the contents management application is designed so as to be provided with the functions of realizing the functions in the past (except for the My Favorite reproducing function, and the Released year reproducing function in the M.L. reproducing function). Thus, there are the circumstances in which the contents management application has not been provided with these list generating functions.

Incidentally, in the All Track, Artist, Album, Genre, and Playlist reproducing functions as well as the reproducing functions in the past, for example, the tracks of a certain artist, or the tracks of a certain genre are treated as objects or the like of the reproduction. Thus, it is expected that the corresponding list is generated on the personal computer 3 side and downloaded into the recording/reproducing apparatus 2 side to be used during the reproduction phase.

However, the contents management application in the past is not provided with the function of reproducing the lists (except for the playlist) in the manner as described above. Along with this, in the recording/reproducing apparatus 2 in the past, those necessary lists have been generated based on the contents management information 1 8b which has been downloaded together with the contents data.

As an example, while as will be described later too, when the Artist reproducing function is selected, the list of the artists is displayed for the purpose of making the user select a desired artist. A list is generated which is obtained by extracting the information on artist names existing in the contents management information 18b within the flash memory 18, and such information list of artists is displayed based on the generated list. In addition, at this time, when a certain artist is specified, a list of the tracks (or the albums) of the certain artist is displayed. Then, a list is generated which is obtained by extracting the information on the track names (the information on the album names) to which the specified artist name in the contents management information 18b is made correspond, and that list of the tracks (albums) is also displayed based on the generated list.

Since the apparatus in the past has no list which is previously generated as described above, the recording/reproducing apparatus 2 side generates the list for generation of the necessary list information based on the contents management information 18b on all such occasions.

In this embodiment as well, no list for the reproducing functions in the past is generated in terms of the contents management application 30a. That is to say, it is supposed that along with that situation, the recording/reproducing apparatus 2 of this embodiment also generates the list for generation of the necessary list information required for the reproducing functions in the past based on the contents of the contents management information 18b on all such occasions.

Operation Procedure and Operation of Recording/Reproducing Apparatus Side.

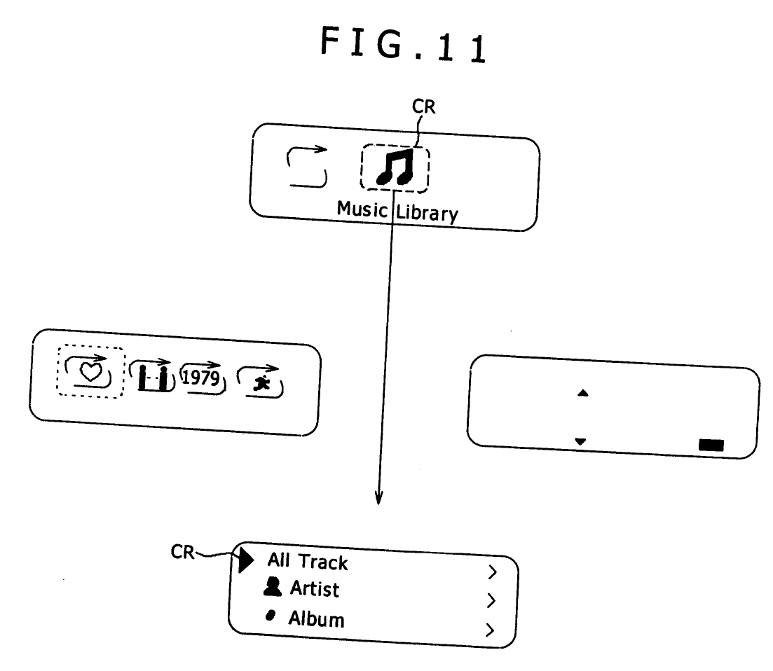

Subsequently, a description will be given with respect to an operation procedure for performing the reproducing function operations shown in FIG. 10, and an operation of the recording/reproducing apparatus 2 side which is performed in accordance with that operation with reference to FIGS. 11 to 17.

Incidentally, changes in display contents on the display portion 15 corresponding to the operation input are shown in these figures.

A description will be given with respect to an operation procedure for selecting any one from among the Intelligent Shuffle reproducing function, the Music Library reproducing function, and the FM receiving function with reference to FIG. 11.

When intending to select any one from among these reproducing functions, the user performs the operation for long depressing the DISP/FUNC key 8a shown in FIG. 9A. It is supposed that the long depressing operation is an operation for continuously depressing the DISP/FUNC key 8a for 0.5 second or more for example. A function selection screen represented by G1 in the figure is displayed on the display portion 15 by performing the operation for long depressing the DISP/FUNC key 8a.

Icons representing the respective functions, i.e., the Intelligent Shuffle reproducing function, the Music Library representing function, and the FM receiving function, a cursor CR for alternatively selecting these icons, and name information on the function represented by the icon selected by the cursor CR are displayed on the function selection screen.

The user can move the cursor CR to select a desired icon from among these icons by performing the FF operation or the FR operation as the rotation operation of the shuttle switch 8d described with reference to FIGS. 9A and 9B. In addition, the user can determine the selected item by depressing the PLAY/STOP key 8c.

When the Intelligent Shuffle reproducing function is selected and determined in the function selection screen, an I.S. selection screen represented by G2 is displayed on the display portion 15. Icons representing the respective I.S. reproducing functions of the My Favorite Shuffle, the Artist Link Shuffle, the Time Machine Shuffle, and the Sports Shuffle, a cursor CR for alternatively selecting these icons, and information on a function name of a mark selected by the cursor CR are displayed on the I.S. selection screen.

In addition, when the Music Library reproducing function is selected and determined on the function selection screen, an M.L. selection screen represented by G3 is displayed on the display portion 15. Name information on the individual reproducing functions (All Track, Artist, Album, My favorite, Released year, Genre, and Playlist) as the M.L. reproducing functions shown in FIG. 10, and a cursor CR for alternatively selecting the name information to select one from among the reproducing functions are displayed on the M.L. selection screen.

While FIG. 11 shows an example in which three names, i.e., All Track, Artist, and Album are displayed as the name information on the M.L. selection screen, this results from the reasons such that the display portion 15 in this case can perform the display for three lines. Other name information is displayed by moving downward or upward the cursor CR for example.

It should be noted that the M.L. selection screen can also be displayed by performing an operation for depressing the SEARCH/MENU key 8b shown in FIG. 9A in addition to performing the operation procedure based on the long depressing of the DISP/FUNC key 8a, and the selection and determination of the M.L. reproducing function on the function selection screen.

In addition, when the FM receiving function is selected and determined in the function selection screen, an FM screen represented by G4 is displayed. For example, the display representing the contents of the present functions such as “FM”, the display of a preset number, and the display of the information or the like on the received frequency are made on the FM screen.

Also, when the FM receiving function is selected and determined in such a manner, the audio signal which is obtained by performing the receiving broadcasting selecting operation by using the tuner T19 shown in FIG. 8 is outputted through the headphones terminal tHP.

Incidentally, no audio signal is outputted in a state in which the function selection screen is displayed by performing the operation for long depressing the DISP/FUNC key 8a. That is to say, in a case where the operation for long depressing the DISP/FUNC key 8a is performed when the track is being reproduced until that time, or when the FM broadcasting is being received, the display of the function selection screen, and the output of the audio signal being reproduced (received) are stopped in correspondence to that case.

As a result, when the DISP/FUNC key 8a is long depressed during the reception of the FM broadcasting, the recording/reproducing apparatus 2 of this embodiment becomes a silent state though the present mode is the FM mode. At this time, in order to perform the operation for generating the FM sound again, the PLAY/STOP key 8c is operated.

In addition, when no operation is performed for equal to or longer than a predetermined period of time during the reception of the FM broadcasting, the operation mode proceeds to a sleep mode. That is to say, the operation mode proceeds to a mode as the sleep mode in which the operation for receiving and generating the FM sound is stopped, and the display portion 15 is turned OFF to reduce the power consumption.

In a case as well where the operation for receiving and generating the FM sound is performed from the sleep mode again, the PLAY/STOP key 8c is depressed. Conversely speaking, no FM output is started in correspondence to any of other operations. However, during the sleep mode, the screen display can be performed when necessary in correspondence to the input through any of other operations.

Incidentally, in this specification, a state until any other reproducing (receiving) function is selected and determined on and after the I.S. reproducing function is selected and determined is referred to as an “I.S. reproducing mode (Intelligent Shuffle reproducing mode)”, or simply referred to as a “shuffle reproducing mode”.

In addition, a state until any other reproducing (receiving) function is selected and determined on and after the M.L. reproducing function is selected and determined is referred to as an “M.L. mode (Music Library mode)”.

Moreover, a state until any other reproducing function is selected and determined on and after the FM receiving function is selected and determined is referred to as an “FM mode”.

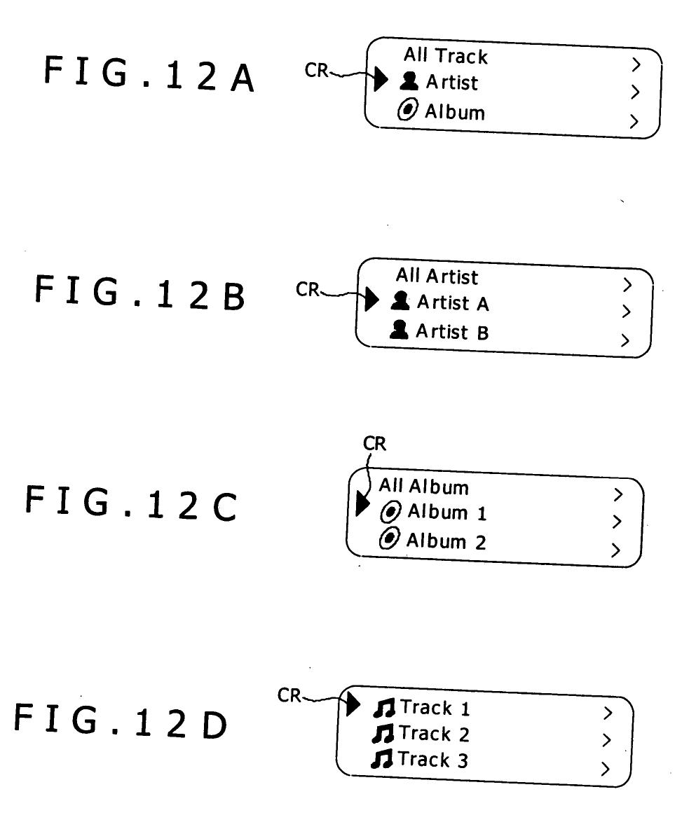

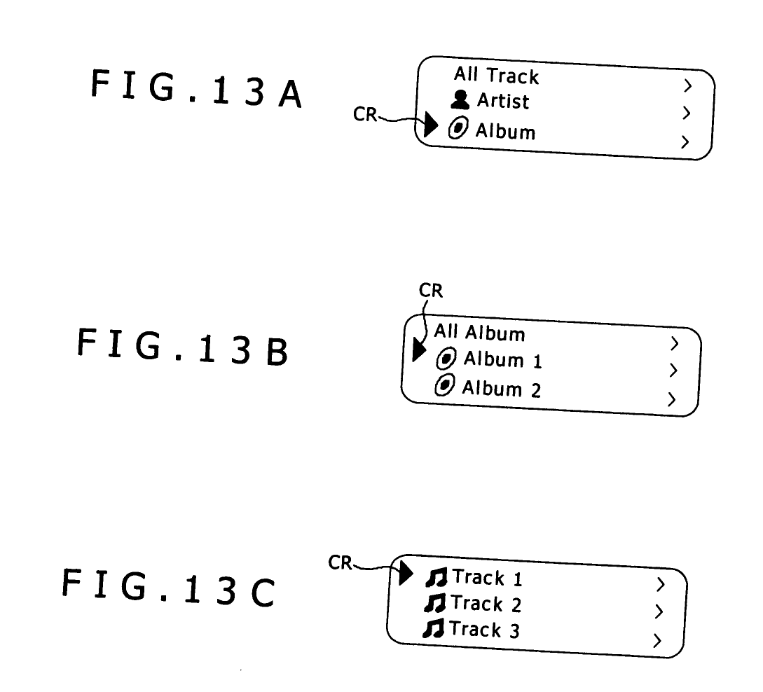

FIGS. 12A to 12D and FIGS. 13A to 13C show screen changes on and after the M.L. reproducing function is determined.

Incidentally, the Artist reproducing function and the Album reproducing function of the M.L. reproducing function will be described with reference to these figures.

When intending to select and determine the Artist reproducing function, as shown in FIG. 12A, in the M.L. selection screen represented by G3 of FIG. 11, the user moves the cursor CR to the name information on the artists and depresses the PLAY/STOP key 8c.

Then, as shown in FIG. 12B, a list of all the artist names is displayed together with “All Artist” on the display portion 15.

At that, while in FIG. 12B as well, information on two artist names is displayed as the information on the artist names, this results from the reasons such that the display for three lines can be made on the display portion 15. Thus, the display of other artist names is made by moving downward or upward the cursor CR for example in this case as well.

It should be noted that this is common to all “list display” which will be described below.

In addition, “all” in “all the artists” in this case means “all” in terms of the range within which the artist names are stored in the flash memory 18.

Also, when “All Artist” is selected and determined in the screen shown in FIG. 12B, the information on all the track names stored as the contents data 18a is rearranged in the order of the artist names to be displayed in the form of a list (at this time, the tracks of the same artist are rearranged in the order of the album names to be displayed).

When one track is selected and determined from the list of the track names, the reproduction is performed in the order of the reproduction based on the list of the rearranged tracks.

The user moves the cursor CR by performing the FF operation/FR operation, and depresses the PLAY/STOP key 8c to issue an instruction for determination of an artist, whereby he/she can select and determine a desired artist from the list of the artists.

When a certain artist is determined from the list of the artists shown in FIG. 12B, “All Album” is displayed together with the list of the albums of the determined artist as shown in FIG. 12C.

When intending to make the reproduction in albums, the user moves the cursor CR by performing the FF operation/FR operation, and depresses the PLAY/STOP key 8c to issue an instruction for determination of an album, thereby selecting and determining a desired album from the displayed list of the albums.

At that, when “All Album” is selected and determined, all the tracks of the artist determined in FIG. 12B are rearranged in the order of the album names to be displayed in the form of the list. At this time, a reproduction object range becomes all the tracks of the determined artist which are displayed in the form of the list. In addition, the order of the reproduction becomes the same as that of the tracks displayed in the form of the list.

When one album is determined from the list of the albums in FIG. 12C, a list of the track names within the determined album is displayed in the manner as shown in FIG. 12D. The user issues an instruction to select and determine the track from the list of the track names shown in FIG. 12D by performing the FF operation/FR operation and by depressing the PLAY/STOP key 8c, whereby he/she can issue an instruction to start the operation for reproducing the determined track.

In this case, the production object range becomes the tracks displayed in the form of the list, i.e., all the tracks within the determined album of the determined artist.

FIGS. 13A to 13C are respectively screen change diagrams explaining the album reproducing function.

When intending to select and determine the Album reproducing function, the user moves the cursor CR to the name information on the albums in the M.L. selection screen in the manner as shown in FIG. 13A and depresses the PLAY/STOP key 8c.

Then, “All Album” is displayed together with a list of all the albums in the manner as shown in FIG. 13B.

The user moves the cursor CR by performing the FF operation/FR operation and issues an instruction for determination of an album by depressing the PLAY/STOP key 8c, whereby he/she can select and determine a desired album from the list of the albums displayed in the form of the list.

At that, when “All Album” is determined, the track names of all the tracks which are stored as the contents data 18a are rearranged in the order of the album names to be displayed in the form of the list. At this time, the order of the reproduction of the contents becomes the same as that of the display of the list. In addition, the reproduction object range becomes all the tracks which are displayed in the form of the list in such a manner.

Also, “all” in “all the albums” stated herein means “all” in terms of the range within which the albums are stored in the flash memory 18.

When one album is determined from the list of the albums in FIG. 13B, the list of the track names within the determined album is displayed as shown in FIG. 13C. The user issues an instruction to select and determine the track from the displayed list of the track names shown in FIG. 13C by performing the FF operation/FR operation and by depressing the PLAY/STOP key 8c, whereby he/she can issue an instruction to start to reproduce the determined track.

In this case, the reproduction object range becomes the tracks displayed in the form of the list, i.e., all the tracks within the determined album.

As can be seen from the descriptions with respect to FIGS. 12A to 12D, and FIGS. 13A to 13C, in this case, in order to perform the M.L. reproduction, the items such as the artist and the album are sequentially determined from the M.L. selection screen to follow the hierarchies, whereby the reproducing function of determining the reproduction object range corresponding to the items of the hierarchies to perform the contents reproduction is realized and the search function of following the hierarchies from the artist to the album to retrieve the desired contents is simultaneously realized.

In this point, the M.L. selection screen is displayed in correspondence to the operation as well for depressing the SEARCH/MENU key 8b as previously stated.

Incidentally, in this embodiment, of the M.L. reproducing function, the Artist reproducing function and the Album reproducing function have been described. However, with respect to the All Track reproducing function, all the track names are displayed in the form of the list in correspondence to the determination thereof. When one track is selected and determined from the list, the selected one track is started to be reproduced. In this case, the reproduction object range becomes all the tracks.

In addition, with respect to the Genre reproducing function, the genres are displayed in the form of the list in correspondence to the determination thereof. When one genre is selected and determined from the displayed list of the genres, the albums belonging to the determined one genre are displayed in the form of the list. The subsequent operations become the same of the foregoing except that with respect to the Artist reproducing function described with reference to FIGS. 12B to 12D, the sorting of “Artist” is replaced with the sorting of “Genre”.

In addition, with respect to the Playlist reproducing function, all the playlists are displayed in the form of the list in correspondence to the determination thereof. When one playlist is selected and determined from the list, all the tracks within the one playlist are displayed in the form of the list. Moreover, when one track is selected and determined from the list of the tracks, the one track is started to be reproduced. In this case, the reproduction object range becomes all the tracks within the determined playlist.

Also, with respect to the My Favorite reproducing function, a predetermined number of upper tracks each being large in number of the reproduction times are extracted from the list of the order of reproduction stored in the flash memory 18 in correspondence to the determination thereof to be displayed in the form of the list. When one track is selected and determined from the list, the one track is started to be reproduced. In this case, the reproduction object range becomes all the tracks (a predetermined number of upper tracks) displayed in the form of the list.

Moreover, with respect to the Released year reproducing function, the information on all the released years existing in the released year list is displayed in the form of the list in correspondence to the determination thereof. When one released year is selected and determined from the list, all the tracks made correspond to the one released year in the released year list are displayed in the form of the list. After this, when one track is selected and determined from the list of the tracks, the one track is started to be reproduced. In this case, the reproduction object range becomes all the tracks (i.e., all the tracks made correspond to the determined released year) displayed in the form of the list.

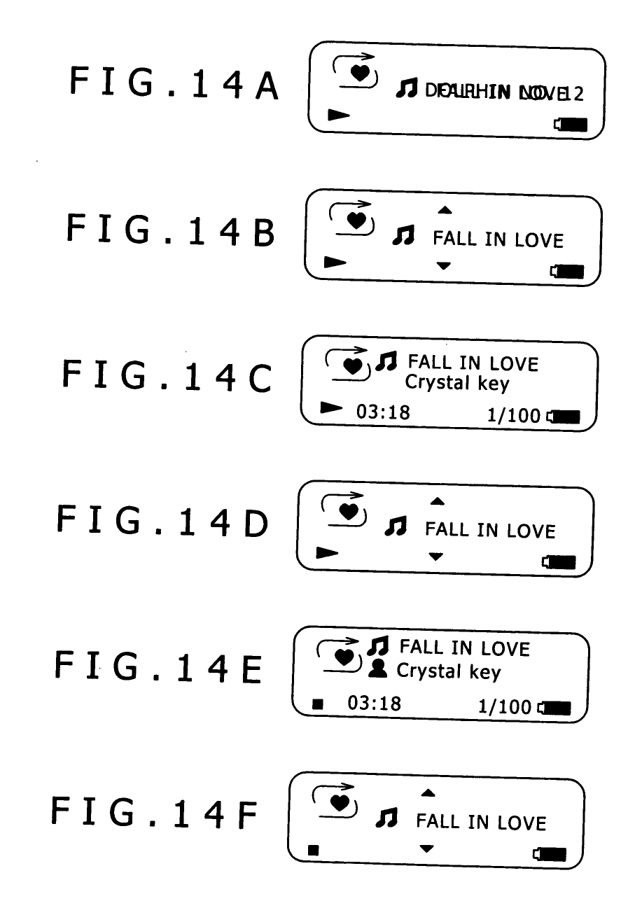

Subsequently, the reproducing functions in the Intelligent Shuffle reproducing function will be described with reference to FIGS. 14A to 17E.

The My Favorite Shuffle reproducing function will be described with reference to FIGS. 14A to 14F.

As previously stated too, the My Favorite Shuffle reproducing function is the reproducing function of performing the shuffle reproduction with a predetermined number of upper tracks each being large in number of the reproduction times as the reproduction object range.

The My Favorite Shuffle reproduction is started in correspondence to selection and determination of the My Favorite Shuffle reproducing function in the I.S. selection screen represented by G2 in FIG. 11.

In correspondence to determining the My Favorite Shuffle reproducing function in the I.S. selection screen in such a manner, the pieces of the information on the track names are displayed on the display portion 15 so as to be sequentially replaced with one another with the information on the track names determined as the reproduction object range as objects as shown in FIG. 14A. That is, the information on the track names is displayed so as to be sequentially replaced with one another with the information on the track names determined as a predetermined number of upper tracks each being large in number of the reproduction times from the list of the order of the reproduction as the objects.

In this embodiment, the display form in which a plurality of information is displayed so as to be sequentially replaced with one another is referred to as “sequential display”.

More specifically, as regards the sequential display in this case, the information is sequentially replaced with one another on a one-by-one basis (on a one track name by one track name basis in this case).

In FIG. 14A, the sequential display is performed over a predetermined period of time. In the case of this embodiment, the sequential display is performed for three seconds for example.

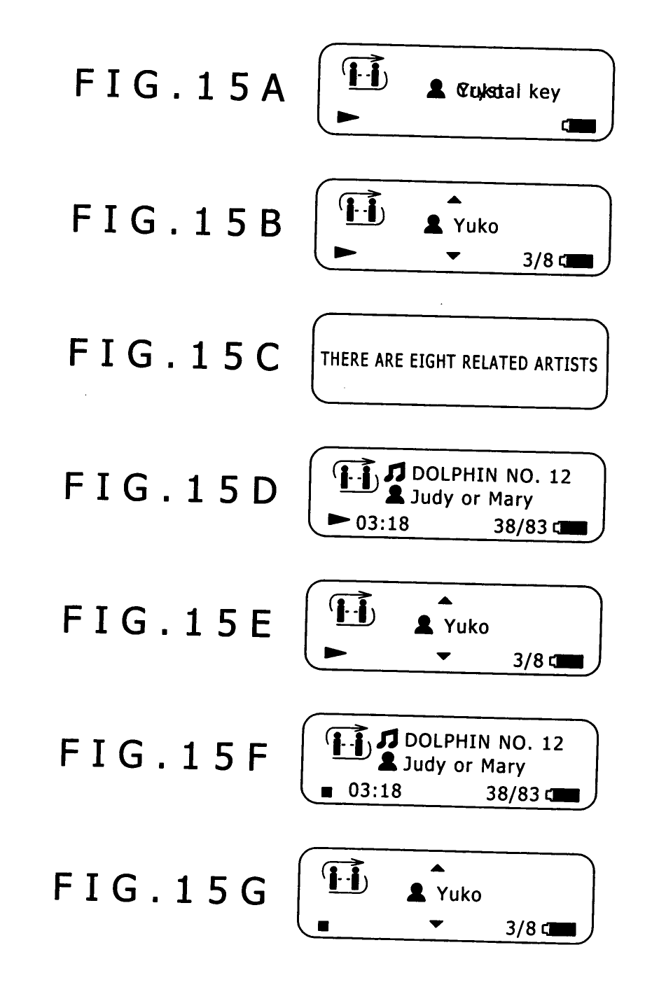

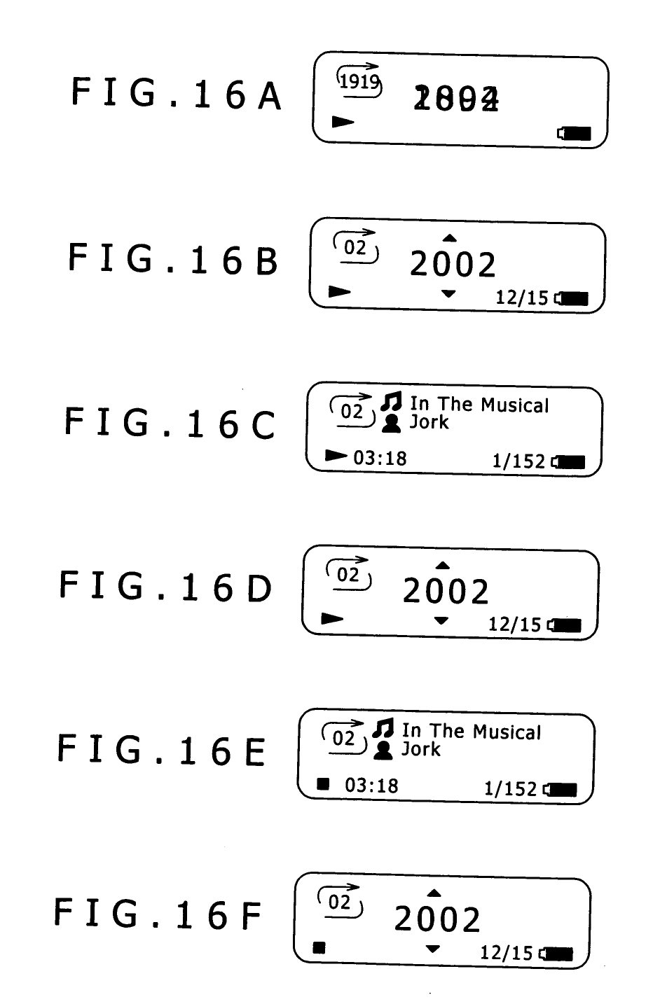

Incidentally, while in FIG. 14A, for the sake of convenience in illustration, a plurality of track names are displayed so as to be superimposed on each other, this shows an image when having seen with the naked eye. Actually, as stated above too, the display is performed so that the track names are displayed so as to be sequentially replaced with one another on a one track name by one track name basis. This is also applied to cases of FIG. 15A and FIG. 16A which will be described later.

In this case, all the selection candidate information cannot be displayed within a predetermined sequential display time depending on the number of the candidate information (the individual track name information in this case) to be sequentially displayed in some cases.

In such cases, a predetermined number of objects of the selection candidate information which can be displayed within a set sequential display period of time have to be sequentially displayed.

Alternatively, in sequentially displaying all the objects of the selection candidate information, the sequential display period of time can be adjusted so that all the objects of the selection candidate information can be sequentially displayed.

At that, in the case of the My Favorite Shuffle reproducing function, an icon representing the My Favorite Shuffle reproducing function is also displayed on the display portion 15. As a result, the user can be informed of the present reproducing function. Incidentally, this is also applied to all the I.S. reproducing functions which will be described below.

After the track names are sequentially displayed over a predetermined period of time in the manner as described above, a track name of the track which is determined in correspondence to the random number in terms of the shuffle reproduction is displayed in the manner as described with reference to FIG. 14B.

Here, as regards “shuffle” in this case, the operation for selecting one object of the candidate information from among a plurality of objects of the selection candidate information is performed so that as described above, firstly, the random number is generated, and the objects of the candidate information, corresponding to the random number, of a plurality of objects of the selection candidate information is selected and determined. That is to say, in this case, of the information on a plurality of track names determined as the reproduction object range, the information on the track name corresponding to the generated random number is selected and determined.

The information on the track name determined in such a manner is also displayed over a predetermined period of time which is set in advance. In this embodiment, a period of time required to display the item which is determined after the sequential display in such a manner is set to 300 ms for example.

After the information on the track name determined in such a manner is displayed over a predetermined period of time, the track name concerned is started to be reproduced.

After the track is started to be reproduced in such a manner, the information shown in FIG. 14C or FIG. 14D is displayed on the display portion 15.

FIG. 14C shows the display contents when the shuttle switch 8d shown in FIG. 9A is slid to the track position (the position P2). FIG. 4D shows the display contents when the shuttle switch 8d is slid to the album position (the position P3).

When the shuttle switch 8d is in the track position and thus the track is being reproduced based on the My Favorite Shuffle reproducing function, at least the information on the track name of the track being reproduced and the information on the artist name of the track concerned are displayed as the information on the track being reproduced on the display portion 15 in the manner as shown in FIG. 14C.

In addition, when the track is being reproduced based on the My Favorite Shuffle reproducing function and the shuttle switch 8d is in the album position, the information on the track name which is selected and determined based on the shuffle in this case is displayed as the information on the track being reproduced on the display portion 15 in the manner as shown in FIG. 14D.

Incidentally, when the track is being reproduced based on the My Favorite Shuffle reproducing function and the PLAY/STOP key 8c is depressed (i.e., the stopping operation is performed), the reproduction of the track is stopped, but the displayed contents at a time point when the stopping operation is performed is maintained on the display portion 15.

FIGS. 14E and 14F show the displayed contents on the display portion 15 when the stopping operation is performed in such a manner. That is, FIG. 14E shows the displayed contents when the shuttle switch 8d is in the track position and the stopping operation is performed. In addition, FIG. 14F shows the display contents when the shuttle switch 8d is in the album position and the stopping operation is performed.

When the stop state continues for equal to or longer than a predetermined period of time, the operation mode proceeds to a sleep mode. In the sleep mode stated herein, the operations of predetermined portions are stopped or limited, e.g., the display portion 15 is turned OFF in order to reduce the power consumption therein.

Subsequently, the Artist Link Shuffle reproducing function will be described with reference to FIGS. 15A to 15G.

The Artist Link Shuffle reproduction is started in correspondence to selection and determination of the Artist Link Shuffle reproducing function in the I.S. selection screen represented by G2 shown in FIG. 11.

In correspondence to determination of the Artist Link Shuffle reproducing function in the I.S. selection screen, firstly, as shown in FIG. 15A, the objects of the information on all the artist names as key Art (refer to FIG. 6) existing in the artist link list are sequentially disposed as the selection candidates on the display portion 15.

In this case as well, the objects of information are displayed so as to be sequentially replaced with one another on a one-by-one basis (on a one artist name by one artist name basis in this embodiment) as the sequential display.

The sequential display shown in FIG. 15A is made over a predetermined period of time (e.g., for a three seconds).

After the sequential display about the artist names is made over the predetermined period of time, as shown in FIG. 15B, the information on the artist name which is determined in correspondence to the random number in terms of the shuffle reproduction is displayed for a predetermined period of time (e.g., for 300 ms).

When the information on the artist name determined in such a manner is displayed for the predetermined period of time, the information on the number of related Arts made correspond to the artist name as the determined key Art in the artist link list is displayed over a predetermined period of time. This display is made in the form of “There are eight related Arts” for example as shown in FIG. 15C. The display is also made for the predetermined period of time such as 300 ms.

After the display about the number of related Arts is made, the information on a given track name is selected and determined from all the track names made correspond to the list of (the key Art and the related Art) made correspond to the determined key Art in the artist link list. For example, the information on the track name located in the head on the list is selected and determined from the track names made correspond to the unit of “the key Art and the related Art”.

Alternatively, the random number is generated and the track name corresponding to the random number is selected and determined, thereby allowing the information on the track name to be determined with the objects of the information on all the track names made correspond to the unit of the key Art and the related Art as objects.

In correspondence to the determination of the information on the track name, the track is started to be reproduced based on the determined track name.

After the determined track is started to be reproduced in such a manner, i.e., when the track is being reproduced based on the Artist Link Shuffle reproducing function, the information shown in FIG. 15D or 15E is displayed on the display portion 15.

In this case as well, FIG. 15D shows the display contents when the shuttle switch 8d is slid to the track position. In this case, as shown in FIG. 15D, the information on the track name of the track being reproduced and the information on the artist name of the track concerned are displayed as the information, on the track being reproduced, which is displayed on the display portion 15.

In addition, FIG. 15E shows the displayed contents when the shuttle switch 8d is slid to the album position. The artist name (the artist name of the key Art) which is selected and determined based on the shuffle operation in this case is displayed as the information, on the track being reproduced, on the display portion 15.

In addition, in a case as well where the stopping operation is performed when the track is being reproduced based on the Artist Link Shuffle reproducing function, similarly to the case of the My Favorite Shuffle reproducing function, the reproduction is stopped, but the displayed contents at a time point when the stopping operation is performed are maintained on the display portion 15.

FIG. 15F shows the displayed contents when the shuttle switch 8d is slid to the track position and the stopping operation is performed. In addition, FIG. 15G shows the displayed contents when the shuttle switch 8d is slid to the album position and the stopping operation is performed.

In this case as well, when the stop state continues for equal to or longer than a predetermined period of time, the operation mode proceeds to the sleep mode.

FIGS. 16A to 16F are respectively diagrams explaining the Time Machine Shuffle reproducing function.

The Time Machine Shuffle reproducing function is started in correspondence to selection and determination of the Time Machine Shuffle reproducing function in the I.S. selection screen.

In correspondence to the determination of the Time Machine Shuffle reproducing function, firstly, as shown in FIG. 16A, the objects of the information on all the released years existing in the released year list are sequentially displayed as the selection candidates on the display portion 15.

In this case as well, as regards the sequential display, the objects of information (the objects of the information on the released years in this case) are displayed so as to be sequentially replaced with one another on a one-by-one basis.

The sequential display shown in FIG. 16A is also made over a predetermined period of time (e.g., over three seconds).

After such sequential display about the released years is made for the predetermined period of time, the information on the released year which is determined in correspondence to the random number in terms of the shuttle reproduction is displayed for a predetermined period of time (e.g., for 300 ms) in the manner as shown in FIG. 16B.

After the information on each released year determined in such a manner is displayed for the predetermined period of time, the information on a predetermined track name is selected and determined from all the track names made correspond to the information on the determined released year in the released year list. For example, the information on the track name, located in the head on the list, of the track names made correspond to the released year concerned is selected and determined.

Alternatively, the random number is generated and the track name corresponding to the random number is selected and determined, thereby the information on the track name to be determined with the objects of the information on all the track names made correspond to the information on the determined released year.

In correspondence to the determination of the information on the track name, the track is started to be reproduced based on the determined track name.

After the track determined in such a manner is started to be reproduced, i.e., when the track is being reproduced based on the Time Machine Shuffle reproducing function, the information shown in FIG. 16C or 16D is displayed on the display portion 15.

In this case as well, FIG. 16C shows the displayed contents when the shuttle switch 8d is slid to the track position. In this case, as shown in the figure, the information on the track name of the track being reproduced and the information on the artist name of the track concerned are displayed as the information, on the track being reproduced, displayed on the display portion 15.

In addition, FIG. 16D shows the displayed contents when the shuttle switch 8d is slid to the album position. The information on the released year which is selected and determined based on the shuffle operation in this case is displayed as the information, on the track being reproduced, on the display portion 15 at this time.

In addition, in a case as well where the stopping operation is performed when the track is being reproduced based on the Time Machine Shuffle reproducing function, similarly to each of the above-mentioned reproducing functions, the reproduction is stopped, but the display contents at a time point when the stopping operation is performed are maintained on the display portion 15.

FIG. 16E shows the displayed contents when the shuttle switch 8d is slid to the track position and the stopping operation is performed. In addition, FIG. 16F shows the displayed contents when the shuttle switch 8d is slid to the album position and the stopping operation is performed.

In this case as well, when the stop state continues for a predetermined period of time, the operation mode proceeds to the sleep mode.

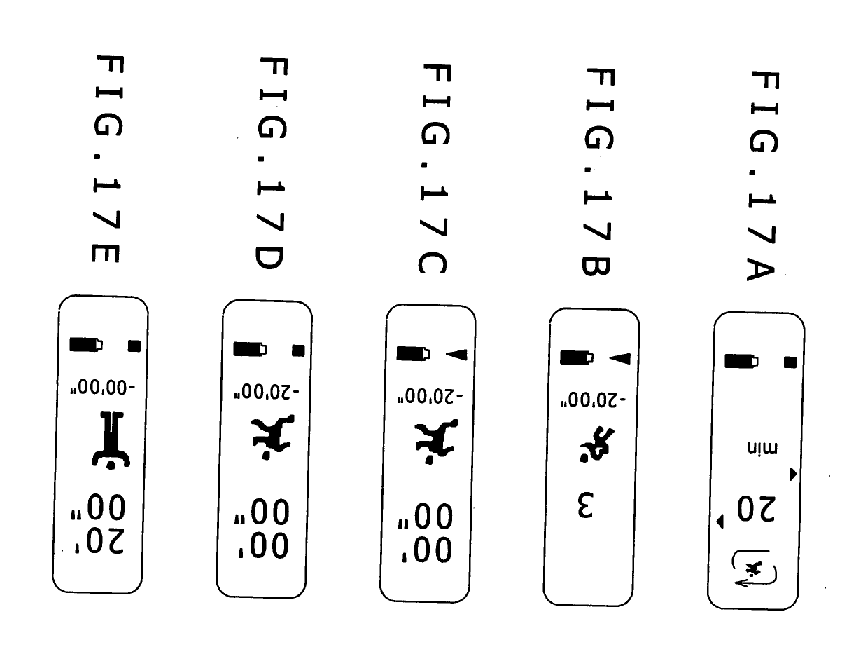

FIGS. 17A to 17E are respectively diagrams explaining the Sports Shuffle reproducing function.

As previously stated too, the Sports Shuffle reproducing function is a shuffle reproducing function with the auto off timer function. The Sports Shuffle reproducing function is started in correspondence to determination and selection of the Sports Shuffle reproducing function in the I.S. selection screen.

In correspondence to the determination of the Sports Shuffle reproducing function, a timer time setting screen shown in FIG. 17A is displayed on the display portion 15. A time setting time (in minutes in this embodiment) is displayed in the timer time setting screen. The user can adjust the timer setting time by performing the FF operation/FR operation in a state in which the timer time setting screen is displayed. At that, the default timer setting time is set to twenty minutes for example. Then, the user can determine the timer setting time by performing the operation for depressing the PLAY/STOP key 8c.

Ready-Go display shown in FIG. 17B is made in correspondence to the operation for determining the timer setting time. The Ready-Go display is used to perform the start count based on a series of screen display such as “3, 2, 1, Go!”. As previously stated, making such Ready-Go display is based on the assumption that the Sports Shuffle reproducing function is used during the jog or the like. At this time, in the screen, before the start, such as “3, 2, 1” in the Ready-Go display, the feeling (the tense atmosphere, etc.) before restart can be performed by displaying an illustration in which a person stands ready to perform the start as shown in the figure.

Upon performing the start count based on such Ready-Go display, the shuffle reproduction is started with all the tracks stored as the contents data 18a as objects. That is, the random number is generated and the track corresponding to the random number is selected and determined with all the tracks as objects, and also the track determined in such a manner is started to be reproduced.

An auto off timer operation is started along with the start of the reproduction. A screen shown in FIG. 17C is displayed on the display portion 15 in correspondence to the start of the auto off timer operation. That is, the information on remaining time of the timer and/or the information on a time elapsed from the start, etc. is displayed on the display portion 15. At this time, for example, the sports feeling can be produced by displaying the information on such a time together with an illustration or the like in which a person is running as shown in the figure.

In a case as well where the stopping operation is performed when the reproduction is being performed based on the Sports Shuffle reproducing function, similarly to each reproducing function, the reproduction is stopped, but the displayed contents at a time point when the stopping operation is performed are maintained on the display portion 15 (refer to FIG. 17D). In this case as well, when the stop state continues for a predetermined period of time, the operation mode proceeds to the sleep mode.

In addition, FIG. 17E shows the displayed contents when the auto off operation is completed after a lapse of the timer setting time. When the reproduction is stopped in the auto off operation, unlike the stop screen shown in FIG. 17D, the information on the timer remaining timer is displayed as “0” and thus the information on the elapsed time from the start is displayed as the set timer time. At this time, for example, the achievement atmosphere can also be produced by displaying an illustration representing that a person reaches the goal such as an illustration representing that the person with arms up in the air as shown in the figure.

Incidentally, in the Sports Shuffle reproducing function, the displayed screen during the reproduction and during the stop phase become identical to each other as shown in FIGS. 17C and 17D irrespective of the track position and the album position of the shuttle switch 8d.

Here, as has been described until now, in selecting and determining one candidate from a plurality of selection candidate groups in terms of the shuffle reproduction, the sequential display in which a predetermined number of objects of the selection candidate information of a plurality of objects of the selection candidate information are displayed so as to be sequentially replaced with one another is made in the recording/reproducing apparatus 2 of this embodiment.

The expectation atmosphere relating to which candidate information is selected and determined by the shuffle as when for example, the lots are drawn by using the roulette can be increased by performing such production. That is to say, this results in that the amusementability which the shuffle reproduction has can be further enhanced.

In addition, as understood from the description as well until now, such sequential display is made during the Intelligent Shuffle reproducing mode phase (the Sports Shuffle reproduction phase is excluded in this embodiment) in order to express and produce the random nature of the shuffle reproduction.

When such sequential display is made during the Intelligent Shuffle reproducing mode, the user can readily and reliably understand, from the fact that the sequential display is made, that the present reproducing mode is the Intelligent Shuffle reproducing mode. That is to say, this enables the user to readily and reliably understand the present reproducing mode.

From the foregoing, according to the exemplary embodiment, the amusementability which the shuffle reproduction has can be further enhanced, and also the excellent user interface can be realized which is intuitive and easy to understand.

Processing Operation

Subsequently, a description will be given with respect to a processing operation which is to be performed in the recording/reproducing apparatus 2 in realizing the Intelligent Shuffle reproducing operation in this embodiment described above, and the sequential display operation which is performed along with the Intelligent Shuffle reproducing operation with reference to flow charts shown in FIGS. 18 to 20.

It should be noted that the processing operations shown in FIGS. 18 to 20 is performed in accordance with the reproduction display program 9a stored in the memory 9 by the controller 6.

Any processes descriptions or blocks in flow charts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

In addition, it is supposed in FIGS. 18 to 20 that a plurality of tracks are recorded as the contents data 18a within the flash memory 18. Incidentally, when one track is recorded, the coping processing for disabling the Intelligent Shuffle reproducing function for selection, or for repeatedly reproducing the track concerned in each reproducing function has to be executed in the function selection screen (G1) shown in FIG. 11.

FIG. 18 shows the processing operation which is to be executed after the My Favorite Shuffle reproducing function is selected and determined.

Referring to FIG. 18, in correspondence to selecting and determining the My Favorite Shuffle reproducing operation on the I.S. selection screen shown in FIG. 11, in step S101, in this case, reference is made to the order list for reproduction times which is stored as the various kinds of lists 18c in the flash memory 18.

Then, in step S102, the information on a predetermined number of upper names each being large in number of the reproduction times is specified as the selection candidates.

Subsequently, in step S103, the processing for sequentially displaying the track names specified as the selection candidates is executed. That is, the control for the display control portion 14 is performed such that the pieces of information on the track names are displayed so as to be sequentially replaced with one another on a one-by-one basis on the display portion 15 with the information on the track names specified as the selection candidates in such a manner as objects over a predetermined period of time which is previously determined as the sequential display time.

At that, as previously stated too, all the objects of selection candidate information cannot be sequentially displayed within the sequential display time (within three seconds in this embodiment) depending on the number of objects of selection candidate information which is sequentially displayed in some cases. In such cases, the instruction is issued so that the objects of selection candidate information which can be displayed in its number within the set sequential display time are supplied to the display control portion 14, and the objects of selection candidate information are displayed so as to be sequentially replaced with one another on one-by-one basis on the display portion 15.

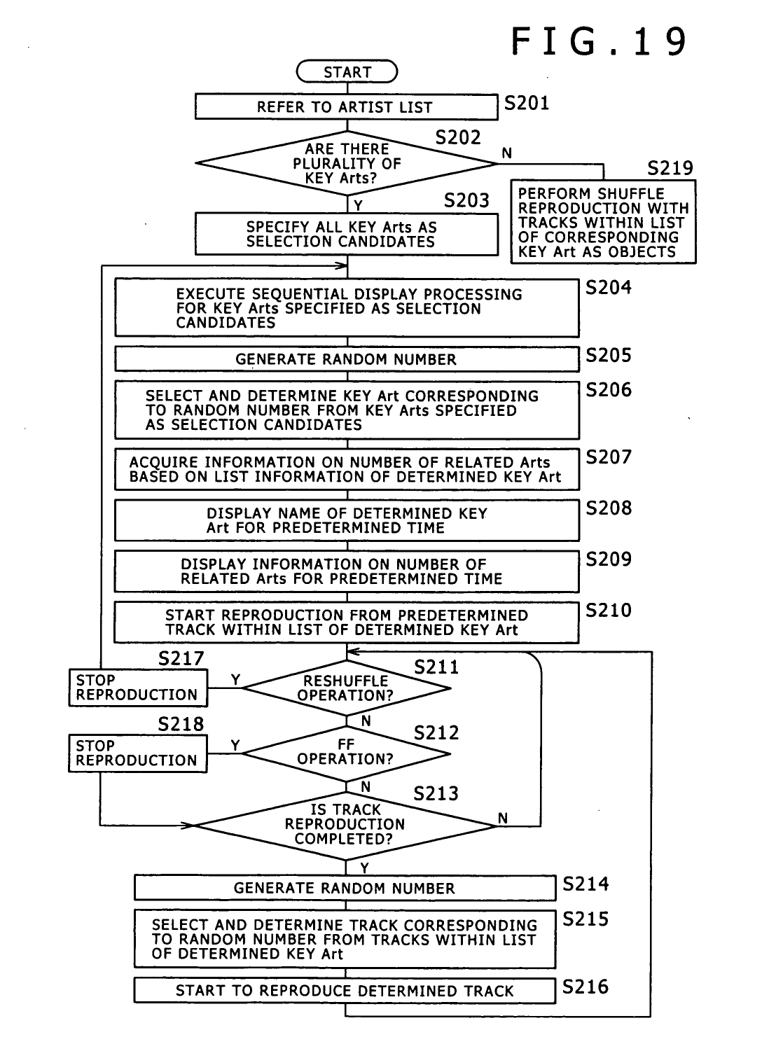

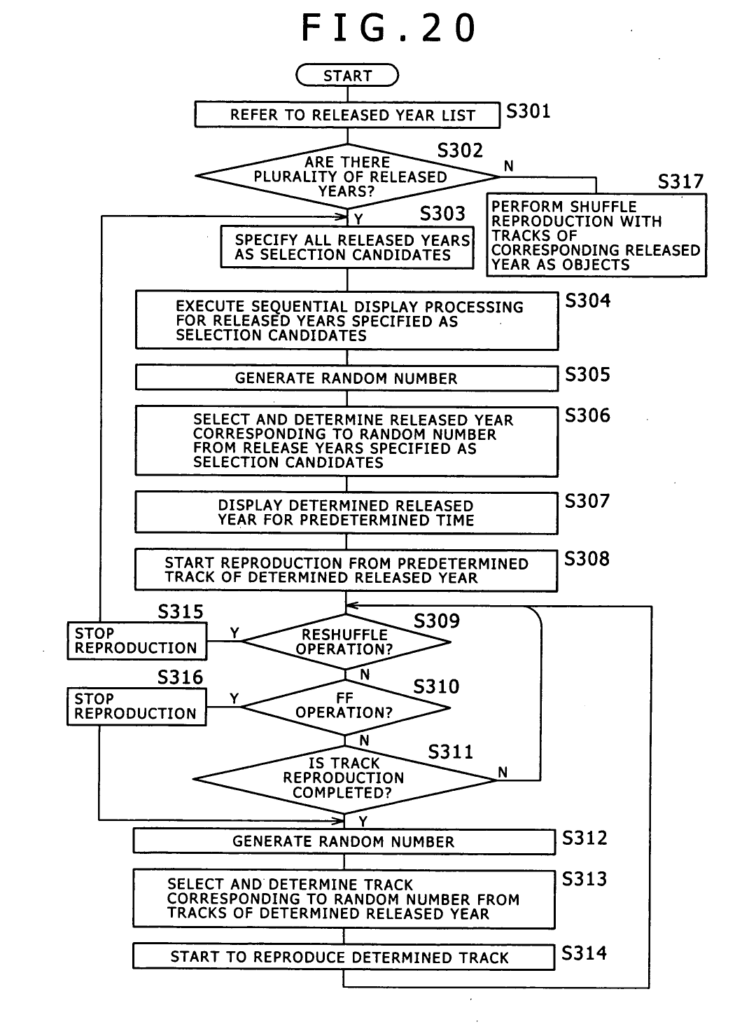

Incidentally, this is also applied to cases of step S204 (refer to FIG. 19) and step S304 (refer to FIG. 20) which will be described later.

After the sequential display processing is executed, a random number is generated in step S104. Subsequently, in step S105, the track name corresponding to the generated random number is selected and determined from the track names specified as the selection candidates. In this case, the controller 6 manages the information on the track names specified as the selection candidates based on the information on numbers of 1 to n for example allocated to the respective track names. Thus, the controller 6 selects and determines the information on the track name having the number corresponding to the generated random number.

Moreover, in step S106, the controller 6 executes processing for displaying the information on the track name determined in such a manner for a predetermined period of time. That is to say, the controller 6 issues an instruction to supply the information on the determined track name to the display control portion 14 to display that information supplied thereto on the display portion 15 for a predetermined period of time. As previously stated too, in this case, the information on the determined track name is displayed over 300 ms for example.

After this, in step S107, processing for starting to reproduce the determined track is executed. That is to say, the information on the contents ID made correspond to the information on the determined track name is acquired based on the contents management information 18b and the processing for starting to reproduce the track, specified by the contents ID, of the tracks stored as the contents data 18a is executed.

Subsequently, in step S108, determination processing relating to whether or not the FF operation is performed is executed. When a negation result is obtained in step S108 because it is determined that the FF operation is not detected as the rotation operation of the shuttle switch 8d shown in FIGS. 9A and 9B, the operation proceeds to step S109 and determination processing relating to whether or not the reproduction of the track is completed is executed. That is, the determination relating to whether or not the track being reproduced is reproduced to the last is performed. When the negation result is obtained in step S109 because it is determined that the reproduction is not completed, the operation returns back to step S108 and the determination processing relating to the FF operation is executed again.

Loop processing for waiting for any one of the FF operation and the completion of reproduction of the track is formed through the processing of Steps S108, S109 to S108.

When an affirmation result is obtained in step S109 because it is determined that the reproduction of the track is completed, a random number is generated in step S110. Then, the operation proceeds to step S111, and the track corresponding to the generated random number is selected and determined from the tracks specified as the selection candidates in step S102. In step S112, processing for starting to reproduce the determined track is executed. After such a new track is started to be reproduced, the operation returns back to step S108 as shown in the figure.

Here, the selection based on the random number is performed such that the same selection candidate is not continuously selected. However, the same selection candidate is continuously selected at relatively high frequency in some cases. As a result, there is the possibility that the meaning of the shuffle is reduced. Then, the shuffle reproduction may be performed such that the same track is not selected until each of the tracks specified as the selection candidates is at least selected once in turn (i.e., until all the tracks are reproduced once). Such an operation, for example, can be realized by adding processing for checking the reproduced tracks and for, when the track selected based on the random number by selection has been checked, generating a random number again to reselect the selection candidate.

In addition, when an affirmation result is obtained in step S108 because it is determined that the FF operation is performed, the operation proceeds to step S113 and the reproduction is stopped. Thereafter, the operation returns back to step S103 and the sequential display processing for the track names specified as the selection candidates is executed again.

That is to say, during the My Favorite Shuffle reproduction phase, the tracks are reselected based on the shuffle by the lottery in correspondence to the FF operation during the reproduction of the track by executing such a processing operation.

Incidentally, in this embodiment, it is referred to as “Reshuffle” that the information specified as the selection candidate information is reselected by the lottery in correspondence to the user operation based on the shuffle.

Here, when during such Reshuffle phase as well, the selection is performed based on the random number, there is also the possibility that the same track is selected at the relatively high frequency. Thus, there is the possibility that the meaning of the shuffle reproduction is reduced. Then, during such a Reshuffle phase as well, the reproduction may also be performed such that similarly to the reselecting of the track by the lottery after completion of the track reproduction, the same track is not selected until each of the tracks specified as the selection candidates is selected once in turn.

It should be noted that while a description based on illustration is omitted here, processing for waiting for the FR operation and for performing the heading for the track being reproduced in correspondence to the FR operation is actually added to the processing operation shown in the figure.

In addition, while a description of this based on illustration is also omitted here, the controller 6 executes processing for monitoring the stopping operation by operating the PLAY/STOP key 8c in parallel with the processing shown in the figure. In correspondence to the stopping operation, the processing operation shown in the figure is completed and reproduction stopping processing is executed.

It should be noted that the processing corresponding to the FR operation, and the stopping operation by the PLAY/STOP key 8c is also similarly executed even in parallel with a processing operation, shown in FIGS. 19 and 20, which will be described below.

Subsequently, FIG. 19 shows a processing operation which is to be performed after the Artist Link Shuffle reproducing function is selected and determined.

Referring to FIG. 19, firstly, in step S201, reference is made to the artist link list in correspondence to selection and determination of the Artist Link List Shuffle reproducing function on the I.S. selection screen.

Then, in step S202, determination processing relating to whether or not there are a plurality of key Arts in the artist link list is executed. That is, there is performed the determination relating to whether or not a plurality of objects of information on the artist names as the key Arts to be arranged in the first hierarchy exist in the artist link list described with reference to FIG. 6.

When a negation result is obtained in step S202 because it is determined that one key Art exists in the artist link list, the operation proceeds to step S219 and the shuffle reproduction is performed with the tracks within the list of the corresponding key Art as objects. More specifically, all the tracks made correspond to the unit (the key Art and the related Art) made correspond to the one key Art in the artist link list are treated as candidate selection candidates, and under this condition, processing in steps S211 to S216 and S218 in the figure is executed. At that, in this case, the track which is firstly reproduced may be made the track, in a predetermined position, such as the track in the head position on the artist link list. Alternatively, the track which is firstly reproduced may be made one which is selected by using the random number.

On the other hand, when an affirmation result is obtained in step S202 because it is determined that there are a plurality of key Arts, in step S203, all the key Arts are specified as the selection candidates. That is to say, the information on the all the artist names, as the key Arts, arranged in the first hierarchy on the artist link list is specified as the selection candidates.

Then, in step S204, the sequential display processing is executed for the key Arts specified as the selection candidates. That is, the display control portion 14 is instructed to cause the display portion 15 to make display such that the pieces of information on the artist names are displayed so as to be sequentially replaced with one another by a one-by-one basis with the information on the artist names, as the key Arts, specified as the selection candidates in such a manner as objects over a predetermined period of time previously determined as the sequential display time.

After the sequential display processing is executed, a random number is generated in step S205, and in step S206, the key Art corresponding to the generated random number is selected and determined from the key Arts (the information on the artist names) specified as the selection candidates. In this case as well, the controller 6 manages the information on the artist names specified as the selection candidates based on the corresponding numbers of 1 to n for example, and selects and determines the information on the artist name having the number corresponding to the generated random number.

Then, in step S207, the information on the number of related Arts is acquired based on the list information on the determined key Art. That is, the number of related Arts made correspond to the determined key Art in the second hierarchy in the artist link list is counted, and the count value is obtained as the information on the number of related Arts.

Moreover, in step S208, there is executed processing for displaying the information on the artist name as the determined key Art for a predetermined period of time. In addition, in step S209, there is executed processing for displaying the information on the number of acquired related Arts for a predetermined period of time.

Incidentally, as previously stated too, the information on the determined artist name and the information on the number of related Arts are displayed over 300 ms for example.

After this, in step S210, there is executed processing for starting the reproduction from a predetermined track within the list of the determined key Art.

That is, a predetermined track name such as a track name located in the head on the list is selected and determined from the track names made correspond to the unit (the key Art and the related Art) made correspond to the determined key Art within the artist link list.

Then, there is executed processing for acquiring the information on the contents ID made correspond to the information on the determined track name in the contents management information 18b and for starting to reproduce the track, specified based on the contents ID, of the tracks stored as the contents data 18a.

Incidentally, as previously stated too, the track to be reproduced can be determined by generating the random number and by selecting and determining the track corresponding to the random number with all the tracks made correspond to the unit of (the determined key Art and the related Art) as objects in addition to selecting and determining the track located in the head on the list as the reproduction start track in such a manner.

Subsequently, in step S211, there is executed determination processing relating to whether or not the Reshuffle operation is performed.

The Reshuffle operation is the FF operation when the shuttle switch 8d is slid to the album position.

Here, in the Artist Link Shuffle reproduction, the shuffle objects are not the tracks as in the above-mentioned My Favorite Shuffle reproduction, but the artists. However, in order to enable the tracks to be skipped, the normal FF operation needs to also be made possible even in the Artist Link Shuffle reproduction. Then, both the Reshuffle instruction in this case and the skip instruction about the tracks become possible by not allocating the normal FF operation (the FF operation when the shuttle switch 8d is in the track position), but allocating the FF operation when the shuttle switch 8d is in the album position thereto.

When a negation result is obtained in step S211 because it is determined that no Reshuffle operation as the FF operation when the shuttle switch 8d is in the album position is detected, the operation proceeds to step S212 and there is executed determination processing relating to whether or not the FF operation (the normal FF operation that is the FF operation when the shuttle switch 8d is in the track position). When a negation result is obtained in step S212 because it is determined that no FF operation is performed, the operation proceeds to step S213 and there is executed determination processing relating to whether or not the reproduction of the track is completed. When a negation result is obtained in step S213 because it is determined that no reproduction of the track is completed, the operation returns back to step S211 and determination processing about the Reshuffle operation is executed again.

In this case, loop processing for waiting for any one of the Reshuffle operation, the FF operation, and the completion of the reproduction of the track is formed by executing the processing of steps S211, S212, S213, to S211.

On the other hand, when an affirmation result is obtained in step S213 because it is determined that the reproduction of the track is completed, in this case as well, similarly to the above-mentioned My Favorite Shuffle reproduction phase, the shuffle reproduction within the range of the tracks specified as the selection candidates is performed.

That is to say, firstly, in step S214, a random number is generated. Then, the operation proceeds to step S215, and the track corresponding to the generated random number is selected and determined from the tracks within the list of the key Art determined in step S206 (i.e., from the tracks made correspond to the unit made correspond to the key Art). After this, in step S216, processing for starting to reproduce the determined track is executed. After the reproduction is started for such a new track, as shown in the figure, the operation returns back to step S211.

At that, in this case as well, the reproduced tracks are checked in order to prevent the same track from being selected until each of the tracks specified as the selection objects is at least selected once in turn. When the track selected based on the random number is checked, processing for generating the random number again to reselect the track can also be added.

Subsequently, when an affirmation result is obtained in step S211 because it is determined that the Reshuffle operation is performed, the operation proceeds to step S217 and the reproduction is stopped. Thereafter, the operation returns back to step S204 and the sequential display processing for the key Arts specified as the selection candidates is executed again.

That is to say, during the Artist Link Shuffle reproduction phase, the Reshuffle for the key Arts is performed in correspondence to the Reshuffle operation during the track reproduction by executing such a processing operation.

At that, in the case of the Reshuffle of the key Arts as well, the selected key Arts are checked in order to prevent the same key Art from being selected until each of the key Arts is at least selected once in turn. When the key Art selected based on the random number is checked, the random number is generated again to reselect key Art. This processing may also be added.

On the other hand, when an affirmation result is obtained in step S212 because it is determined that the FF operation is performed, after the operation proceeds to step S218 and the reproduction is stopped, the operation proceeds to step S214 which is previously described. As a result, the next track is selected through the shuffle by the lottery to start the reproduction in accordance with an instruction to skip any of the reproduced tracks by the FF operation.

In addition, FIG. 20 shows a processing operation which is to be performed after the Time Machine Shuffle reproducing function is selected and determined.

Referring to FIG. 20, firstly, in step S301, reference is made to the released year list in correspondence to selecting and determining the Time Machine Shuffle reproducing function on the I.S. selection screen.

Then, in step S302, there is executed determination processing relating to whether or not there are a plurality of released years in that released year list. That is, there is performed determination relating to whether or not a plurality of objects f information on the released years which are to be arranged in the first hierarchy exist in the released year list described with reference to FIG. 7.

When a negation result is obtained in step S302 because it is determined that there is only one object of information on the released years, the operation proceeds to step S317, and the shuffle reproduction is performed with the tracks within the list of the corresponding released year. More specifically, processing of steps S310 to S314 and S316 is executed with all the tracks made correspond to the one released year in the released year list (selection candidates). Incidentally, in this case as well, the track which is to be firstly reproduced is made one, in a predetermined position, such as the track in the head position on the list, or one selected and determined by using the random number.

On the other hand, when an affirmation result is obtained in step S302 because it is determined that there are a plurality of key Arts, in step S303, all the released years on the released year list are specified as the selection candidates.

Then, in step S304, the sequential display processing is executed for the released years specified as the selection candidates. That is, the display control portion 14 is instructed to make the display such that the objects of information on the released years are displayed so as to be sequentially replaced with one another on a one-by-one basis on the display portion 15 with the information on the released years specified as the selection candidates in such a manner for a predetermined period of time previously determined as the sequential display time.

After the sequential display processing is executed, a random number is generated in step S305, and in step S306, the released year corresponding to the generated random number is selected and determined from the released years specified as the selection candidates. In this case as well, the controller 6 manages the information on the released years specified as the selection candidates based on the corresponding numbers of 1 to n for example, and selects and determines the information on the released year having the number corresponding to the generated random number.

Then, in step S307, there is executed processing for displaying the information on the determined released year for a predetermined period of time. Incidentally, as previously stated, such information on the released year is also displayed over 300 ms for example.

After this, in step S308, there is executed processing for starting the reproduction from the predetermined track of the determined released year.

That is, the predetermined track name such as the track name located in the head on the list is selected and determined from the track names made correspond to the determined released year in the released year list. Then, the information on the contents ID made correspond to the information on the determined track name is acquired from the contents management information 18b. Also, there is executed processing for starting to reproduce the track, specified with the contents ID, of the tracks stored as the contents data 18a.

At that, in this case as well, the track to be started to be reproduced can also be determined by generating the random number, and by selecting and determining the track corresponding to the random number with all the tracks made correspond to the released year as objects.

Subsequently, in step S309, there is executed determination processing relating to whether or not the Reshuffle operation is performed. That is to say, in this case as well, since the shuffle objects are not the tracks, but the released years, the FF operation for issuing an instruction to skip any of the normal tracks and the shuffle operation for shuffling the released years are performed separately from each other. It should be noted that the FF operation when the shuttle switch 8d is in the album position is allocated to the shuffle operation as well in this case.

When a negation result is obtained in step S309 because it is determined that no shuffle operation as the FF operation when the shuttle switch 8d is in such an album position is detected, the operation proceeds to step S310 and there is executed determination processing for determining whether or not the FF operation (the normal FF operation that is the FF operation when the shuttle switch 8d is in the track position) is performed. When a negation result is obtained in step S310 because it is determined that no FF operation is performed, the operation proceeds to step S311 and there is executed determination processing for determining whether or not the reproduction of the track is completed. When a negation result is obtained in step S311 because it is determined that no reproduction of the track is completed, the operation returns back to step S309 and the determination processing for the shuffle operation is executed again.

In this case as well, loop processing for waiting for any one of the shuffle operation, the FF operation, and the completion of the reproduction of the track is formed by executing such processing of steps S309, S310, S311, to S309.

On the other hand, when an affirmation result is obtained in step S311 because it is determined that the reproduction of the track is completed, in this case as well, similarly to each shuffle reproduction described above, the shuffle reproduction within the range of the tracks specified as the selection candidates is executed.

That is to say, a random number is generated in step S312. Then, the operation proceeds to step S313, and the track corresponding to the generated random number is selected and determined from the tracks of the released year determined in step S306. After this, in step S314, processing for starting to reproduce the determined track is executed. After such a new track is started to be reproduced, as shown in the figure, the operation returns back to step S309.

At that, in this case as well, the reproduced tracks are checked in order to prevent the same track from being selected until each of the tracks specified as the selection candidates is at least selected once in turn. When the track selected based on the random number is checked, the random number is generated again to reselect the track. This processing may also be added.

Subsequently, when an affirmation result is obtained in step S309 because it is determined that the shuffle operation is performed, the operation proceeds to step S315 and the reproduction is stopped. Thereafter, the operation returns back to step S304, and the sequential display processing is executed for the released years specified as the selection candidates again.

That is to say, the Reshuffle for the released years is performed in correspondence to the shuffle operation during the track reproduction in the Time Machine Shuffle reproduction phase by performing such a processing operation.

At that, in the case of the Reshuffle as well of the released years, the selected released years are checked in order to prevent the same released year from being selected until each of the released years is at least selected once in turn. When the released year selected based on the random number is checked, the random number is generated again to reselect the released year. This processing may also be added.

On the other hand, when an affirmation result is obtained in step S310 because it is determined that the FF operation is performed, the operation proceeds to step S316 and the reproduction is stopped. Thereafter, the operation proceeds to step S312 which is previously described. As a result, the next track is selected through the shuffle and the reproduction is started in accordance with an instruction to skip any of the reproduced tracks by performing the FF operation.

While in FIGS. 18 to 20, after each shuffle reproduction is started, the tracks within the reproduction object range are repeatedly reproduced until the stopping operation is performed, the reproduction may also be automatically stopped after each of the tracks within the reproduction object range is selected once in turn. More specifically, in the case of the My Favorite Shuffle reproduction, the reproduction is stopped after each of a predetermined number of upper tracks is selected once in turn. In addition, in the case of the Artist Link Shuffle reproduction, the reproduction is stopped after each of all the tracks made correspond to the unit made correspond to the determined key Art is selected once in turn. Also, in the case of the Time Machine Shuffle reproduction, the reproduction is stopped after each of all the tracks made correspond to the determined released year is selected once in turn.

In realizing such an operation, processing for checking whether or not each of all the tracks specified as falling within the reproduction object range is selected once in turn and for stopping the reproduction in correspondence to that each of all the tracks is selected once in turn may be added to each of the processing shown in FIGS. 18 to 20.

Here, as understood from the description as well until now, the shuffle reproducing function and the sequential display function of this embodiment descried with reference to FIGS. 14A to 16F are realized by performing the processing operation shown in FIGS. 18 to 20. Then, such a processing operation is realized by the reproduction display program 9a stored in the recording/reproducing apparatus 2. Thus, the shuffle reproducing function and the sequential display function of this embodiment can be realized by executing the reproduction display program 9a.

At that, in the description until now, as regards “the sequential display”, the objects of selection candidate information are displayed so as to be sequentially replaced with one another on a one-by-one basis on the display portion 15. However, as regards the sequential display, the objects of selection candidate information may not be displayed so as to be sequentially replaced with one another on a one-by-one basis, but the objects of selection candidate information may be displayed so as to be sequentially replaced with one another on a plural objects by plural objects.

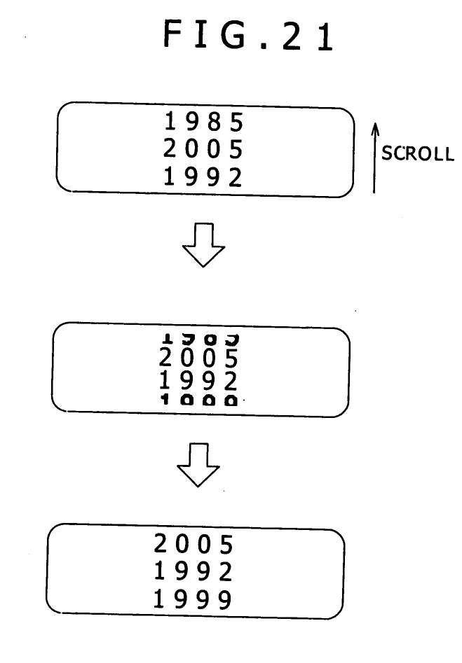

FIG. 21 shows an example in a case where the objects of selection candidate information are displayed so as to be sequentially replaced with one another on a plural objects by plural objects basis. It should be noted that while FIG. 21 shows the example in which the selection candidate information is the information on the released years, the same display form can be adopted in a case as well where the selection candidate information is other information.

As shown in FIG. 21, the sequential display in this case is set such that a plurality of objects of selection candidate information (three pieces of selection candidate information in the example shown in the figure) can be simultaneously displayed on the display portion 15, and thus, a plurality of objects of selection candidate information can be shown at a time from the list of the selection candidate information which is scrolled in a predetermined direction.

It should be noted that the sequential display showing a plurality of objects of selection candidate information at a time is not limited to the example shown in the figure. For example, in the example of FIG. 21, the objects of selection candidate information at a time are displayed so as to be sequentially replaced with one another on a plural objects by plural objects basis without performing the scroll. Thus, other various ways are expected.

In addition, as for the sequential display, the objects of selection candidate information can be displayed so as to be sequentially replaces with the objects of selection candidate information in a cross-fade manner. That is, the display is repeatedly made such that the selection candidate information being displayed is gradually faded out, and the selection candidate information to be displayed next time is superimposed on the fade-out display to be gradually faded in.

In addition, as regards the direction for the shuffle, the selection candidate information being sequentially displayed can be displayed so as to swing in a plurality of directions such as vertical and horizontal directions on the screen.

<2. Functions Coping with Application in the Past>

Premise and Problems

Here, as touching thereon in the description as well of FIG. 10, of the various kinds of reproducing functions which the recording/reproducing apparatus 2 of this embodiment has, the Intelligent Shuffle (I.S.) reproducing function and a part (the My Favorite reproducing function and the Released year reproducing function) of the Music Library (M.L.) reproducing function are the functions which are extended in the present recording/reproducing apparatus 2. In addition, the M.L. reproducing function (the All Track, Artist, Album, Genre, and Playlist reproducing functions) other than those reproducing functions are the functions in the past.

Then, the contents management application 30a on the personal computer 3 side is also extended in function from the contents management application corresponding to the apparatus in the past, in correspondence to the present function extension.

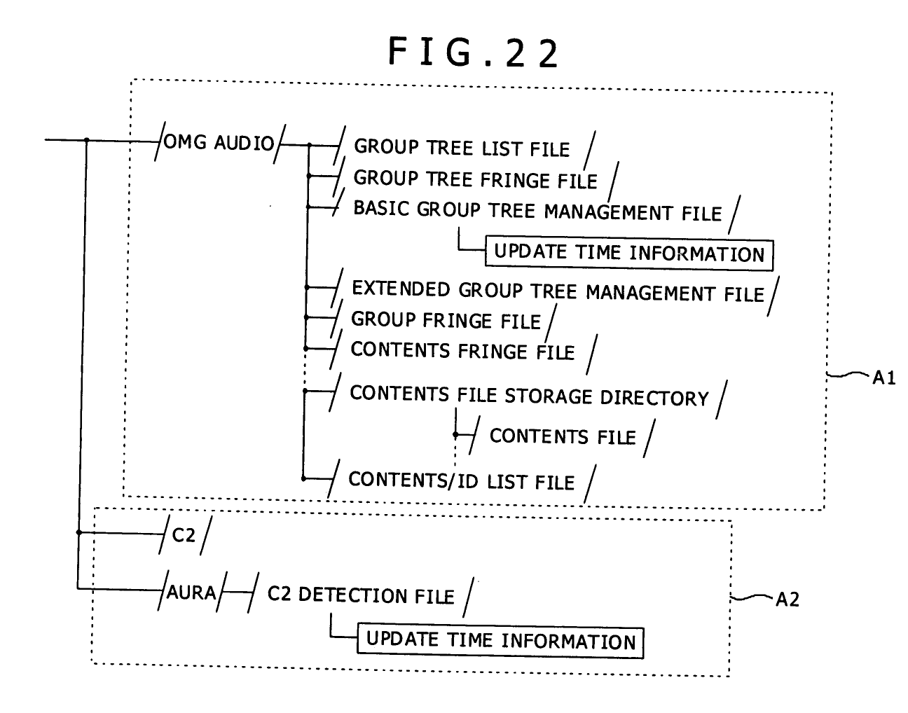

FIG. 22 schematically shows a structure of the data file which is generated by the present contents management application 30a and downloaded into the recording/reproducing apparatus 2 side.

As a premise, as previously described too, the recording/reproducing apparatus 2 is the apparatus corresponding to the USB mass storage class. Thus, when the personal computer 3 and the recording/reproducing apparatus 2 are connected to each other, the personal computer 3 recognizes the recording/reproducing apparatus 2 as an outside storage apparatus. FIG. 22 shows, when the personal computer 3 side recognizes the recording/reproducing apparatus 2 as the outside storage apparatus in such a manner, an actual structure of the data which contains the contents data 18a, the contents management information 18b, and the various kinds of lists 18c stored in the flash memory 18 on the recording/reproducing apparatus 2 side and which is downloaded from the personal computer 3 side into the recording/reproducing apparatus 2.

As shown in FIG. 22, two areas, i.e., an area (an area indicated by A1 in the figure) in which the various kinds of files required to realize the function in the past are stored, and an area (an area indicated by A2 in the figure) in which the file added in order to realize the present extension function is stored are prepared for the data which is downloaded from the personal computer 3 side into the recording/reproducing apparatus 2 to be stored in the flash memory 18.

Under a directory called “OMG AUDIO”, as shown in the figure, a group tree list file, a group tree fringe file, a basic group tree management file, an extension group tree management file, a group fringe file, a contents fringe file, contents files in a contents storage directory, a contents ID list file, etc. are stored in the area A1.

The group tree list file is a list file of a reproduction list. The reproduction list means information representing the reproduction order of the tracks which are classified and managed in predetermined numbers. A list which is automatically generated based on the additive information of the contents classified and managed in albums or in artists is also contained together with the playlist which is generated based on the user operation in the group tree list file.

The reproduction files such as the playlist which are classified in albums are actually managed in the form of a tree structure called a group tree.

In addition, the group tree fringe file is a file in which fringe data having the additive information such as titles for the group trees is stored.

The basic group tree management file is a default reproduction list, i.e., the so-called TOC file in which the contents management order is defined. Incidentally, as shown in the figure, an area in which the update time information of the file is recorded is secured within the basic group tree management file.

In addition, the extension group tree management file is a file in which the reproduction order of the tracks is defined separately from the default reproduction list. In this case, the extension group tree management file may be expected as having the same meaning as that of the playlist or the reproduction list which is managed in albums.

The group fringe file is a file in which fringe data (additive information) for the groups defined in the respective group trees is stored.

In addition, the contents fringe file is a file in which fringe data (additive information) of the tracks (contents files) as the contents is stored.

In this case, the contents files are stored in the contents file storage directory. List information on the contents ID for uniquely defining these contents files is stored in the form of the contents ID list file shown in the figure.

In addition, in FIG. 22, a directory called “C2” and a directory called “AURA” exist in the area A2. Of these directories, a file called a C2 detection file for realization of the present extension function is stored under the directory “AURA”. That is to say, the list information on the order list for reproduction times, the artist link list, and the released year list is stored in the C2 detection file.

In addition, as shown in the figure, an area in which the update time information on the file is provided within the C2 detection file.

Here, the function in the past is the function which is realized by using the contents management application and the recording/reproducing apparatus in the past. From such a premise in the past, in realizing the present function extension, the data structure is adopted in which the area A2 required to realize the present extension function is added to the area A1 required for realization of the function in the past.

By adopting such a data structure, the area A1 shown in FIG. 22 can be maintained by the contents management application in the past as well.

In addition, the present contents management application 30a adapted to realize the present extension function as well as the function in the past can maintain the area A2 as well as the area A1.

In this connection, for the present recording/reproducing apparatus 2, the contents management application in the past can maintain the area A1 in the manner as described above. Thus, the combination of the present recording/reproducing apparatus 2 with the contents management application in the past results in that the personal computer 3 side can also download the contents managed by the application in the past into the recording/reproducing apparatus 2 side.

However, even when the contents data can be downloaded in such a manner, the contents management application in the past has no function of generating the various kinds of lists required to realize the present extension functions (the I.S. reproducing function, and the My Favorite reproducing function and the Released year reproducing function of the M.L. reproducing function). Thus, up to the list information thereon is not downloaded. Consequently, when the data managed by the contents management application in the past is downloaded into the recording/reproducing apparatus 2 side in such a manner, the reproducing functions in the past can be realized, while when the instructions to perform the respective extension functions are issued, the reproducing operation is performed in a state in which there is no necessary information. As a result, there is the possibility that nonconformity occurs in the recording/reproducing apparatus 2.

In addition, in a case as well where the tracks for several objects of music, for example, are additionally downloaded by the application in the past after for example, the contents data was downloaded previously by the present contents management application 30a in addition to the case where the data is downloaded into the recording/reproducing apparatus 2 side by only the application in the past in such a manner, there is the possibility that a problem arises.

In this case, even when the added tracks are managed by the application in the past and thus they are downloaded into the recording/reproducing apparatus 2, the additive information thereon (the information on the track names, the artist names, and the released years) is not reflected to the lists required for realization of the present extension functions. Hence, in this case, with the reproduction extension functions, the reproduction cannot be performed with the added tracks as the objects of the reproduction.

Since the user has the intention of adding the tracks, as a matter of course, there is the possibility that he/she supposes that those tracks are also treated as the objects of the reproduction with the extended functions. In spite of this, if any of the added tracks is not contained in the reproduction range, the user is quite capable of being thrown into confusion.

Operation of Recording/Reproducing System

In this embodiment, an operation for limiting the execution of the present extended functions in correspondence to a data update state of the flash memory 18 is performed in order to prevent the nonconformity and user confusion when the maintenance is performed by such a application in the past.

Here, according to the description until now, even when the contents data is downloaded even once by the present contents management application 30a, no nonconformity accompanying the issue of the instructions to perform the reproducing operation by using the extended functions is caused since the necessary lists such as the order list for reproduction times, the artist link list, and the released year list exist.

Here, from this, it is determined whether or not the contents data is downloaded even once by the present contents management application 30a. When it is determined that no contents data is downloaded by the present contents management application 30a, the recording/reproducing apparatus 2 side disables any of the extended reproducing functions to be performed. As a result, it is possible to avoid the execution of the reproducing operation using the extended functions in the state in which there is no necessary list, and it is possible to prevent the nonconformity from being caused in the recording/reproducing apparatus 2.

On the other hand, when it is determined that the contents data is downloaded even once by the present contents management application 30a, it becomes a problem whether or not the update right before the download is performed by the present contents management application 30a

As will be described below, the reason for this is that if the update right before the download is performed by the present contents management application 30a, the recording/reproducing apparatus 2 side is usually maintained in a state in which the reproducing operations can be performed by using the extended functions.

Here, while a description of this has been omitted for the sake of convenience, the present contents management application 30a is provided with a function as well of, when there are the tracks downloaded by the contents management application in the past in the recording/reproducing apparatus 2 side after the present contents management application 30a is connected to the recording/reproducing apparatus 2 side, updating the lists comprising of the order list for reproduction times, the artist link list, and the released year list into the lists to which the information on those tracks is also reflected.

In this case, the present contents management application 30a, for example, can specify the tracks added to the recording/reproducing apparatus 2 side by the application in the past by confirming the coherency between the area A1 and the area A2 shown in FIG. 22. That is to say, as understood from the descriptions given with reference to FIGS. 5 to 7, the order list for reproduction times, the artist link list, and the released year list which are stored in the area A2 should become the lists with all the contents files (tracks) stored in the area A1 as the objects. Thus, any one of these lists is treated as the object and all the tracks existing in the list concerned are compared with all the tracks stored in the area A1. When there is the track not existing on the list concerned in the area A1, the track concerned can be judged to be one which is added by the application in the past.

It should be noted that the technique for specifying the track added by the application in the past is not limited to the technique described herein, and thus the various techniques may be expected.

After the track added by the application in the past is specified, the information on the number of the reproduction times, the information on the artist name and the related artist, and the information on the released year are acquired which are made correspond to the specified track, and the information on the lists comprising of the order list for reproduction times, the artist link list, and the released year list which are to be downloaded into the recording/reproducing apparatus 2 side is updated based on the these pieces of the information.

The list information which is updated in such a manner is downloaded into the recording/reproducing apparatus 2 side, whereby the recording/reproducing apparatus 2 side can normally perform the reproducing operation even for the track added by the application in the past based on the present extended functions.

Since the present contents management application 30a is provided with the function of updating the various kinds of lists, if the update right before the predetermined operation (download) is performed by the present contents management application 30a, the recording/reproducing apparatus 2 side can normally perform the reproduction based on the extended functions.

On the other hand, if the update right before the predetermined operation is performed by the application in the past, there is the possibility that the track is added in which the additive information thereof is not reflected to the various kinds of lists. Thus, there is the possibility that the recording/reproducing apparatus 2 side cannot normally perform the reproduction based on the extended functions.

Then, in a case where the update was performed previously by the present contents management application 30a, but the update right before the predetermined operation is not performed by the present contents management application 30a, i.e., in a case where there is the track added by the application in the past, and there is the possibility that the additive information on that track is not reflected to the various kinds of lists required for realization of the extended functions, the recording/reproducing apparatus 2 side puts restrictions thereon so that the I.S. reproducing function and the part (the My Favorite reproducing function and the Released year reproducing function) of the M.L. reproducing functions as the present extended functions are not performed.

That is, in order to prevent the user from being confused due to the impossibility of the reproduction based on the extended functions for the added track as described above, in this case, the recording/reproducing apparatus 2 side puts restrictions thereon so that any of those reproducing function cannot be performed.

On the other hand, if the update right before the predetermined operation is performed by the present contents management application 30a, the recording/reproducing apparatus 2 performs the operation as usual. That is, the recording/reproducing apparatus 2 permits the present extended reproducing functions to be performed.

In order to realize the operation described above, the recording/reproducing apparatus 2 side needs to judge whether or not the update was performed previously by the present contents management application 30a and whether or not the update right before the predetermined operation is performed by the present contents management application 30a.

The former, i.e., the judgment relating to whether or not the update was performed previously by the present contents management application 30a can be performed by determining from the data structure within the flash memory 18 shown in the FIG. 22 whether or not there is even one file in the area A2. That is to say, the reason for this is that the area A2 is the area which can be maintained by the present contents management application 30a.

For example, in this case, whether or not the update was performed previously by the present contents management application 30a is determined depending on whether or not the C2 detection file exists in the area A2 within the flash memory 18.

In addition, whether or not the update right before the predetermined operation is performed by the present contents management application 30a is judged by determining whether or not a plurality of pieces of update time information shown in FIG. 22 agree with one another.

As previously stated too, the present contents management application 30a can maintain both the areas A1 and A2. At this time, an area in which the update time information of the file recorded is provided in the basic group tree management file in the area A1. For this reason, the present contents management application 30a is adapted to record the update time information within the basic group tree management file. In addition, an area in which the same file update time information recorded is provided in the C2 detection file as well within the area A2. For this reason, the present contents management application 30a which can maintain both the areas A1 and A2 is adapted to record both the pieces of the update time information after the update of the data. That is to say, when the present contents management application 30a updates the data based on this, the pieces of update time information agree with each other in both the areas.

On the other hand, since the application in the past can maintain the area A1, the update time information is recorded in the area A1.

On the basis of this, in this case, the recording/reproducing apparatus 2 determines whether or not both the update time information within the area A1 (basic group tree management file) and the update time information within the area A2 (C2 detection file) agree with each other. When both the objects of the update time information agree with each other, it is determined that the update right before the predetermined operation is performed by the present contents management application 30a. On the other hand, when both the objects of the update time information do not agree with each other, it is determined that the update right before the predetermined operation is performed by the application in the past.

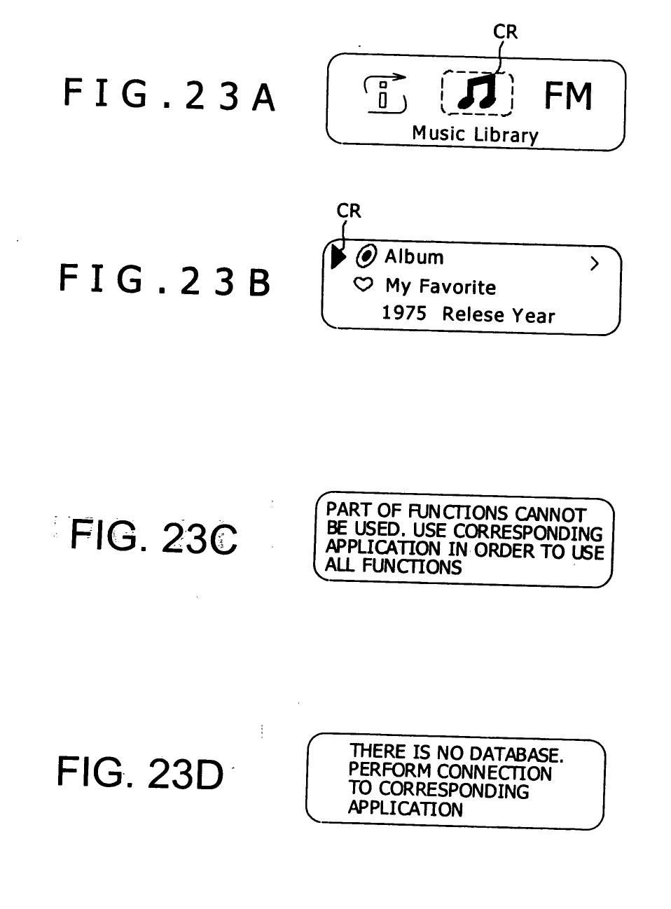

In addition, an operation for limiting the reproduction based on the extended functions which is performed in correspondence to both a case where the determination results show that no update was performed even once in the past by the present contents management application 30a and a case where the determination results show that the update was performed once by the present contents management application 30a, but the update right before the predetermined operation is not performed by the present contents management application 30a is concretely performed in the manner as shown in FIGS. 23A and 23B.

FIGS. 23A and 23B show examples of screen display on the display portion 15 when such reproduction based on the extended functions is limited. FIG. 23A shows a display example of a function selection screen (refer to FIG. 11) for limitation of the I.S. reproducing functions.

In addition, FIG. 23B shows a display example of an M.L. selection portion (G3 in FIG. 11) for limitation of the part of the M.L. reproducing function as the extended functions.

Firstly, when the I.S. reproducing function is limited in the manner as shown in FIG. 23A, the so-called gray-out display (the display lightness of this icon is made darker than that of any of the icons representing other reproducing functions) is performed for the icon representing the I.S. reproducing function in the function selection screen. In addition, the control is performed such that the icon representing the I.S. reproducing function is disabled to be selected. That is, the function in the past comprising of the M.L. reproducing function and the FM reproducing function can be selected and determined in the function selection screen in this case.

As a result, it is possible to prevent the instruction to perform the I.S. reproducing function from being issued.

In addition, in limiting the part (the My Favorite reproduction function and the Released year reproduction function) of the M.L. reproducing function as the extended functions, the icon representing the My Favorite reproduction function and the icon representing the Released year reproduction function on the M.L. selection screen are displayed in the form of gray-out as shown in FIG. 23B. Thus, the control is performed such that those reproducing functions cannot be selected. That is to say, as a result, it is possible to prevent the instruction to perform the part of the M.L. reproducing function as the extended functions from being issued.

By performing the operation as described above, any of the extended reproducing functions can be controlled so as not to be performed in correspondence to the case where the data downloaded by the application in the past is stored on the recording/reproducing apparatus 2 side, and the case where the update was performed in the past by the present contents management application 30a, but the update right before the predetermined operation is not performed by the present contents management application 30a (i.e., the case where there is the possibility that the track is added by the application in the past).

Incidentally, while in this exemplary embodiment, in order to disable the instruction to perform the extended reproducing functions to be issued, the icon representing the corresponding function is displayed in the form of gray-out, even when for example, no corresponding icon is displayed, the same effects as those of the foregoing can be obtained. Alternatively, though the corresponding icon is displayed as usual, the determination operation for the icon concerned is not accepted, whereby it is possible to prevent any of the extended reproducing functions from being performed.

Now, in this case, if the function limiting operation as described above is performed without giving the user a previous notice, he/she cannot grasp the cause of the limitation, and thus may be confused.

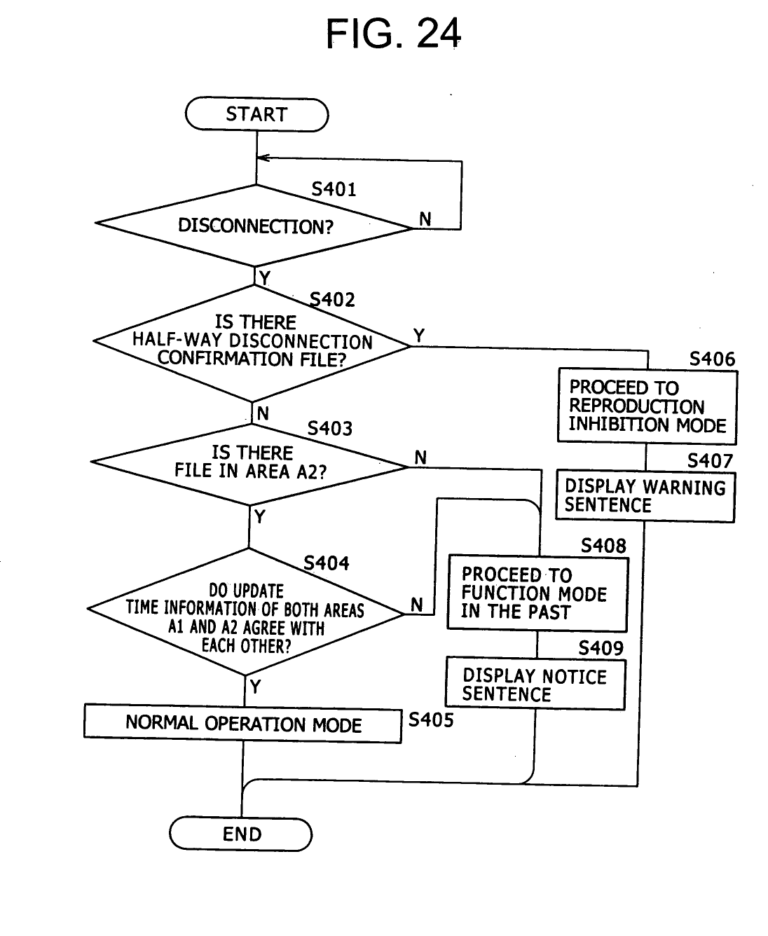

Thus, in response to the establishment of the conditions about the limitation operation extension, a notice sentence as shown in FIG. 24 is displayed on the display portion 15 at timing (e.g., upon release of the USB connection) at which the data update (download) from the personal computer 3 side into the recording/reproducing apparatus 2 side is completed. For example, “A part of the functions cannot be used. Use the corresponding application in order to use all the functions”, etc. are displayed as the notice sentence.

In such a manner, a message is displayed which gives the user a previous notice showing the effect that a part of the functions cannot be used, whereby it is possible to prevent the user from being confused.

In addition, when the message for urging the user to use the corresponding application (the contents management application 30a in this case) is displayed together as in this example, it is possible to urge the user to set the recording/reproducing apparatus 2 in a state in which the normal reproduction can be performed by using the function of updating the various kinds of lists by the previously stated contents management application 30a. That is, it is possible to provide the solution for setting the recording/reproducing apparatus 2 in a state in which all the reproducing functions can be used as usual.

Now, the description has been given by setting that the download of the contents performed between the personal computer 3 and the recording/reproducing apparatus 2 is normally completed forth as a premise until now. However, it is also guessed that during the data update for example, the USB cable is pulled out, thereby interrupting the connection.

When during the data update, the connection is interrupted in such a manner, the recording/reproducing apparatus 2 side cannot perfectly update the data. Thus, even when the connection is interrupted in such a manner, if the recording/reproducing apparatus 2 side reproduces the contents, there is the possibility that the nonconformity occurs in point of that the contents are reproduced in a state in which there is no necessary data.

Then, the recording/reproducing apparatus 2 detects such an interrupt together, and when detecting the interrupt, prohibits all the reproducing functions from being performed.

More specifically, such an interrupt is detected based on presence or absence of a confirmation file which is generated upon the establishment of the connection between the personal computer 3 and the recording/reproducing apparatus 2, and erased upon the completion of the data update.

Here, the contents management application 30a is provided with a function, as a contents downloading function, of generating the confirmation file as described above (called a half-way disconnection confirmation file as well) to record the confirmation file in the flash memory 18 side upon the establishment of the connection between the personal computer 3 and the recording/reproducing apparatus 2, and of erasing the confirmation file upon completion of the data update. Such a function of recording/erasing the confirmation file is one with which the contents management application in the past is also provided.

Upon disconnection of the connection, the recording/reproducing apparatus 2 side determines in correspondence to the function of recording/erasing the confirmation file whether or not the confirmation file exists in the flash memory 18. When determining that the confirmation file remains in the flash memory 18, the recording/reproducing apparatus 2 side prohibits the contents data from being reproduced because it is judged that the update is interrupted halfway. More specifically, as for the prohibition of the reproduction, all the key operation inputs from the operation portion 8 are not accepted.

Performing such a reproduction prohibiting operation results in that it is possible to prevent the contents data from being reproduced in the state in which there is no necessary data, and thus it is possible to effectively prevent the nonconformity from occurring.

At that, in this case as well, when the user is not given the previous notice in the form of a message sentence or the like, there is the possibility that the user is confused.

Then, in this case, a warning sentence as shown in FIG. 25 is displayed on the display portion 15 in correspondence to that during the disconnection of the connection as described above, the confirmation file remains in the flash memory 18.

For example, “There is no database. Perform the connection to the corresponding application”, etc. are displayed as the warning sentence. Displaying the message, such as “There is no database”, for informing the user of the effect that the data update is imperfect results in that it is possible to prevent the user from being confused along with the prohibition of the reproduction.

In addition, when the message for urging the user to perform the connection to the corresponding application is displayed together as in this example, similarly to the display of the notice sentence during the previously stated limiting operation, the user is urged to perform the connection again, whereby it is possible to urge the user to set the recording/reproducing apparatus 2 in a state in which the normal reproduction becomes possible.

Processing Operation

FIG. 24 is a flow chart showing a processing operation to be performed in order to realize the operation which is performed in correspondence to the file update phase described above.

Incidentally, the controller 6 in the recording/reproducing apparatus 2 performs the processing operation shown in the figure. That is to say, as described with reference to FIG. 8 too, the controller 6 performs the processing operation shown in the figure in accordance with the update phase processing program 9b stored in the memory 9.

Referring to FIG. 24, firstly, in step S401, the controller 6 waits for the disconnection (release of connection) of the connection to the personal computer 3 side. The USB controller 16 shown in FIG. 8, for example, can determine presence or absence of the disconnection of the connection to the personal computer 3 side based on presence or absence of a connection release notification which is made upon release of the connection to the personal computer 3.

When determining that the disconnection was made, in step S402, the controller 6 determines whether or not there is a half-way disconnection confirmation file. That is, the controller 6 determines whether or not the half-way disconnection confirmation file remains in the flash memory 18. When an affirmation result is obtained in step S402 because it is determined that the half-way disconnection confirmation file remains in the flash memory 18, the operation proceeds to step S406 and the controller 6 executes processing for making the operation mode proceed to a reproduction prohibition mode. That is, the controller 6 sets its own mode as the reproduction prohibition mode so as to obtain a state of not accepting all the key inputs from the operation portion 8 on and after this.

As a result, the previously stated reproduction prohibiting operation is realized. Thus, it is possible to prevent the contents data from being reproduced in the state in which there is no necessary data, and it is possible to effectively prevent the nonconformity from occurring.

Subsequently, in step S407, the controller 6 executes a warning sentence displaying processing. That is, the controller 6 supplies the warning message data (display data) such as “There is no database. Perform the connection to the corresponding application” which is set in advance to the display control portion 14, and issues an instruction to display that warning message data on the display portion 15 over a predetermined period of time.

Incidentally, in this case, for example, about three seconds are set as the display time of the warning sentence.

On the other hand, when a negation result is obtained in step S402 because it is determined that there is no half-way disconnection confirmation file, in step S403, the controller 6 determines whether or not there is the file in the area A2. That is to say, in this case, the controller 6 determines whether or not there is the C2 detection file as the file of the area A2.

When a negation result is obtained in step S403 because it is determined that there is no C2 detection file, the operation proceeds to step S408, and the controller 6 executes processing for making the operation made proceed to the function mode in the past. Here, the case where no C2 detection file remains in the flash memory 18 means that the recording/reproducing apparatus 2 is not updated even once by the present contents management application 30a. Consequently, according to the previously stated description about the operation, in this case, the icon representing the I.S. reproducing function is displayed in the form of gray-out in the function selection screen to disable that icon to be selected. Also, the icon representing the My Favorite reproducing function and the icon representing the Released year reproducing function are displayed in the form of gray-out each in the M.L. selection screen to disable these icons to be selected.

The processing for making the operation mode proceed to the function mode in the past in step S408 is processing in which the controller 6 sets its own mode so that during in displaying the function selection screen and the M.L. selection screen in such a manner, the corresponding icons are displayed in the form of gray-out each to disable those icons to be selected.

The reproducing functions as the extended functions are disabled to be performed in correspondence to that the recording/reproducing apparatus 2 is not updated even once by the present management contents application 30a, whereby it is possible to prevent the contents data from being reproduced in the state in which there is no necessary data and it is possible to effectively prevent the nonconformity from occurring.

Subsequently, in step S409, the controller 6 executes processing for displaying a notice sentence. That is to say, the controller 6 supplies the message data such as “A part of the functions cannot be used. Use the corresponding application in order to use all the functions”, and issues the instruction to display the message data on the display portion 15 for the predetermined period of time.

Displaying such a notice sentence results in that as previously stated, it is possible to prevent the user from being confused, and it is possible to urge the user to set the recording/reproducing apparatus 2 in the state in which the normal reproduction becomes possible.

At that, for example, about three seconds are set as the display period of time for the notice sentence.

On the other hand, when an affirmation result is obtained in step S403 because it is determined that there is the file in the area A2, in step S404, the controller 6 determines whether or not pieces of update time information of both the areas A1 and A2 agree with each other. That is to say, the controller 6 determines whether or not the agreement is obtained between the update time information within the basic group tree management file under the “OMG AUDIO” directory in the area A1 and the update time information within the C2 detection file under “AURA” in the area A2.

When a negation result is obtained in step S404 because it is determined that the both the objects of update time information do not agree with each other, the operation proceeds to step S408 previously stated. After executing the processing for making the operation mode proceed to the function mode in the past in step S408, the controller 6 executes the processing for displaying the notice sentence in step S409.

Here, the case where the negation result is obtained in step S404 corresponds to a case where while it is determined in the determination processing in step S403 that the update is performed once by the present management contents application 30a, it is determined based on the disagreement between the two objects of update time information that the update right before the predetermined operation is not performed by the present management contents application 30a.

Consequently, according to the processing operation when the negation result is obtained in step S404, the proceeding for making the operation mode proceed to the function mode in the past (S408) and the display of the notice sentence (S409) can be made in correspondence to the case where while it is determined that the update is performed once by the present management contents application 30a, it is determined that the update right before the predetermined operation is not performed by the present management contents application 30a. That is, the execution of the reproducing operation based on the extended functions can be limited and the message sentence which gives the user the previous notice representing that effect can be displayed in correspondence to a state in which there is the possibility that the tracks are left added by the contents management application in the past.

On the other hand, when an affirmation result is obtained in step S404 because it is determined that the two pieces of update time information in both the areas A1 and A2 agree with each other, the operation proceeds to step S405 and the operation mode proceeds to the normal operation mode. That is, the normal operation is caused to be performed in which the recording/reproducing apparatus 2 can perform all the reproducing functions.

It should be noted that while for the sake of convenience in description, the processing of step S405 has been shown as the active processing called the processing for making the operation mode proceeds to the normal operation mode, in order to cause the normal operation to be actually performed, the special processing executed by the controller 6 is unnecessary. Consequently, from this meaning, the processing of step S405 is unnecessary. Thus, the processing operation shown in the figure has to be directly completed in correspondence to that the affirmation result is obtained in step S404.

Here, as understood by referring to FIG. 24, the half-way disconnection detecting processing during the data update (S401) and the processing for coping therewith (S406 and S407) are used together with each other as the function of coping the application in the past of this embodiment.

If the controller 6 determines based on the check (S404) about the two objects of update time information whether or not the update right before the predetermined operation is performed by the present management contents application 30a without using the half-way disconnection detecting processing and the processing for coping therewith together with each other, even when during the update by the present management contents application 30a, for example, the connection is interrupted at timing at which one objects of update time information of any one in the area A1 or A2 is updated, limitation of the functions (S408) and the display of the notice sentence (S409) are merely made as the update by the application in the past, and thus the reproduction by the function in the past becomes possible. That is to say, though the contents data is not perfectly updated, the contents data can be reproduced on the recording/reproducing apparatus 2 side. Thus, the occurrence of the nonconformity accompanying this is feared.

Then, if the half-way disconnection detecting processing and the processing for coping therewith are used together with as in this embodiment, in such a case as well, the user can be normally urged to perform the re-connecting. As a result, it is possible to prevent the nonconformity from occurring due to that the reproduction becomes possible in a state in which the update is uncompleted.

At that, in the above description, the case has been exemplified where when the recording/reproducing apparatus 2 determines that while the contents data was downloaded once by the present management contents application 30a, the update right before the predetermined operation is not performed by the present management contents application 30a, any of the extended functions is disabled to be performed. As previously stated too, according to this procedure, it is possible to prevent the user from being confused due to that the contents data which is expected to have been added does not become the object of the reproduction.

However, since the notice sentence is displayed, this confusion can also be expected to be avoided. In addition, even if any of the tracks added by the apparatus in the past is excluded from the object of the reproduction, it cannot be denied that if anything, the user may desire to perform the extended functions.

Then, when it is determined that while the contents data was downloaded once by the present management contents application 30a, the update right before the predetermined operation is not performed by the present management contents application 30a, the notice sentence is displayed, and the extended functions can be permitted to be performed.

While this embodiment has been described, the present invention should not be limited to this embodiment which has been described so far.

For example, the case where the audio data is used as the contents data has been exemplified as this embodiment. However, the video data in which a still picture or a moving picture constituting a movie, a television program, a video program, a photograph, a picture, a chart or the like is made contents, or arbitrary data in which an electronic computer originated book (E-Book), a game, software or the like is made contents can be used as the contents data.

In addition, the case where the information processor is the personal computer has been exemplified in this embodiment. However, the information processor in the present invention can also be constituted by any other suitable computer apparatus such as Personal Digital Assistants (PDA), a domestic game apparatus, an information household electric appliance or the like.

In addition, in this embodiment, the configuration of the recording/reproducing apparatus 2 having the semiconductor memory built therein as the recording medium has been exemplified. However, the present invention can be widely applied to a case where the recording/reproducing apparatus 2 is configured so as to be capable of recording/reproducing the contents data in correspondence to a necessary recording medium such as a CD, a DVD, a hard disc, or a memory card.

However, when the corresponding recording medium is a disc-like recording medium, it is possible to provide a buffer memory for buffering data read out from and written to the recording medium.

In addition, in this embodiment in which the semiconductor memory is built in the recording/reproducing apparatus 2, after the reproduction of the track is completed, or the reproduction is stopped in accordance with the skip instruction, the next object of music to be reproduced is selected by the lottery in correspondence to the generated random number. However, the disc-like recording medium has a tendency to increase waiting time for the user until reproduction of the next track all the more since it takes time to read out the contents data from the recording medium.

Then, in order to cope with such a situation, the next track to be reproduced is selected by the lottery in correspondence to the generated random number during the reproduction of the track, and the track concerned is started to be reproduced in correspondence to completion/stop of the reproduction.

In addition, in this embodiment, the recording/reproducing apparatus 2 is configured in the form of the portable type audio player (/recorder). However, the recording/reproducing apparatus 2 of the present invention has to have the function of recording/reproducing the contents data in/from the necessary recording medium, and thus may also be configured in the form of any other suitable electric apparatus such as a mobile phone, or a PDA.

In addition, in this embodiment, the main body of the recording/reproducing apparatus 2 is provided with the display device. However, the display device of the recording/reproducing apparatus 2, for example, is provided in the remote controller portion which is connected in a wired manner in some cases. In such cases, the main body side of the recording/reproducing apparatus 2 has to perform the same display control for such an outside display device.

In addition, in this embodiment, the case has been exemplified where the order list for reproduction times, the artist link list, and the released year list are generated as the various kinds of lists generated by the present management contents application 30a in correspondence to realization of the extended functions comprising of the reproducing function of the order list for reproduction times (the My Favorite Shuffle and My Favorite reproducing functions), the Artist Link Shuffle reproducing function, and the Released year reproducing function (the Time Machine Shuffle and Released year reproducing functions) with which the recording/reproducing apparatus 2 side is provided. However, the kinds of extended functions with which the recording/reproducing apparatus 2 side is provided, the lists which are generated in correspondence to the kinds of extended functions are not limited thereto.

Obviously, readily discernible modifications and variations of the present invention are possible in light of the above teachings. It is therefore to be understood that within the scope of the appended claims, the invention may be practiced otherwise than as specifically described herein. For example, while described in terms of both software and hardware components interactively cooperating, it is contemplated that the system described herein may be practiced entirely in software. The software may be embodied in a carrier such as magnetic or optical disk, or a radio frequency or audio frequency carrier wave.

The present invention contains subject matter related to Japanese Patent Application JP 2005-259765, filed in the Patent Office of Japan on Sep. 7, 2005, the entire contents of which are incorporated herein by reference.

What is claimed is:

1. A recording/reproducing apparatus, comprising:
a reproducing section configured to reproduce data from a recording medium in which at least content data and its additive data are recorded; and
a control section configured to display a plurality of pieces of selection candidate object information in correspondence to content data, sequentially for a predetermined time on a display portion when a shuffle reproduction mode is selected.

2. The recording/reproducing apparatus according to claim 1, wherein the plurality of selection candidate object information is additive data of content data which is recorded in said recording medium.

3. The recording/reproducing apparatus according to claim 1, wherein the control section determines content data to be reproduced and performs an object of selection candidate object information in correspondence to the determined content data to be displayed after sequentially displaying of the plurality of selection candidate object information.

4. The recording/reproducing apparatus according to claim 3, wherein the candidate object information is name information of an artist.

5. The recording/reproducing apparatus according to claim 4, wherein the control section perform information related to the determined name information of an artist to be displayed after displaying the determined name information.

6. The recording/reproducing apparatus according to claim 1, wherein the selection candidate object information is title information in correspondence to content data in the recording medium.

7. The recording/reproducing apparatus according to claim 1, wherein the selection candidate object information is released year information.

8. The recording/reproducing apparatus according to claim 1, wherein said control section performs the plurality of objects of selection candidate object information to be displayed sequentially for a predetermined time on a display portion when a shuffle reproduction mode is selected while content data is being reproduced.

9. The recording/reproducing apparatus according to claim 1, wherein said control section selects other content data to be reproduced subsequently to a reproduction of a content data.

10. The recording/reproducing apparatus according to claim 1, wherein said control section selects other content data to be reproduced subsequent to an instruction to skip a reproduction of content data.

11. The recording/reproducing apparatus according to claim 1, wherein said control section performs selection candidate object information to be displayed in the same display area on said display portion so as to be sequentially replaced with one another on a one piece by on piece basis.

12. The recording/reproducing apparatus according to claim 1, wherein said control section performs the object of selection candidate object information to be displayed on said display portion so as to be scrolled.

13. The recording/reproducing apparatus according to claim 1, wherein said apparatus has a plural of shuffle reproduction modes, and said control section determines a selected shuffle reproduction mode and performs objects of the selection candidate object information in correspondence to the content data of the selected shuffle reproduction mode.

14. A display control method of a recording/reproducing apparatus:
selecting a shuffle reproduction mode;
displaying sequentially a plurality of selection candidate object information in correspondence to content data recorded in the reproducing apparatus for a predetermined period of time.

15. A recording/reproducing apparatus, comprising:
a means for reproducing data from a recording medium in which at least content data and its additive data are recorded; and
a means for controlling a plurality of object selection candidate object information in correspondence to the content data to be displayed sequentially for a predetermined time when a shuffle reproduction mode is selected.
